(19) United States
(12) Patent Application Publication
(10) Pub. No.: US 2008/0263143 A1
(43) Pub. Date: Oct. 23, 2008

(54) DATA TRANSMISSION METHOD, SYSTEM, APPARATUS, AND COMPUTER READABLE STORAGE MEDIUM STORING PROGRAM THEREOF

(75) Inventors: Eiichi TAKAHASHI, Kawasaki (JP); Tatsuro MATSUMOTO, Kawasaki (JP); Kazuo SASAKI, Kawasaki (JP); Masayuki FUKUI, Kawasaki (JP); Ai YANO, Kawasaki (JP); Masahiro HARA, Kawasaki (JP); Yutaka IWAYAMA, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/104,822

(22) Filed: Apr. 17, 2008

(30) Foreign Application Priority Data
Apr. 20, 2007 (JP) 2007-112365

(51) Int. Cl. G06F 15/16

(52) U.S. Cl. 709/203

(57) ABSTRACT

Upon receiving a request from a personal computer for obtaining data of an advertisement image, an advertisement server reads data of an advertisement image stored in a storage. A superimposition image DB stores data of superimposition images to be superimposed on part of advertisement images and data of superimposition areas in the advertisement images where the superimposition images are superimposed. A superimposition image is superimposed on a superimposition area in the advertisement image. Data of the advertisement image superimposed with the superimposition image is transmitted to the personal computer. The personal computer receives position data input as a result of operation performed on the advertisement image superimposed with the superimposition image and transmits the position data to the advertisement server. The advertisement server receives the position data and determines whether the position data exists within the superimposition area whose data is stored in the superimposition image DB.

### BACKGROUND OF THE INVENTION

1. Field of the Invention

The present invention relates to a data transmission method which allows a data transmission apparatus to transmit data of a display image displayed on part of a web page.

2. Description of the Related Art

In recent years, banner advertisement images have been distributed on the World Wide Web from advertisement servers. When a user downloads web page data from a web server, a banner advertisement image or images distributed from the advertisement server are displayed on a browser window in addition to main content. When the user clicks on the banner advertisement image, the user can jump from the web page to a linked destination so as to display details corresponding to the banner advertisement image of interest on the browser window.

On the other hand, the advertisement server counts number of clicks of the user on the banner advertisement image and an advertising company managing the advertisement server receives compensation from its advertiser in accordance with the counted number of clicks. When the owner of the web page is an “affiliate”, he or she receives a share. Thus, since the compensation is obtained in accordance with the number of clicks on the banner advertisement image, a malicious affiliate may fraudulently obtain the share by creating software that causes multiple clicks on the banner advertisement image. In addition, a malicious user (not an affiliate) may attack a specific advertiser by creating software that causes enormous amount of clicks on the banner advertisement image to make the advertiser pay for high cost of advertisement. Conventionally, in order to prevent such a fraud, the number of clicks per unit time or a click pattern is recognized to identify the fraud. Examples of such a technology include Japanese Laid-open Patent Publications No. 2002-7424 and No. 2002-245339.

However, the conventional methods of identifying frauds have low identification accuracy and cannot prevent frauds quickly since they record histories of multiple numbers of clicks to make the identification. The publications described above do not disclose any means for solving the problems.

### SUMMARY

The present invention has been conceived in view of the foregoing situation, and an object of the present invention is to provide a data transmission method which can prevent billing based on fraudulent operation by superimposing, on a display image serving as a banner advertisement image, an superimposition image for prompting a user's operation and by determining that an operation is valid when the operation is performed on the superimposition image.

According to a first aspect of the present invention, there is provided a data transmission method for transmitting data of an image to be displayed on a web page. The data transmission method is executed by a data transmission apparatus which is capable of communicating with a user computer. The data transmission method includes the steps of: reading data of a display image which is stored in a storage on receiving a request of obtaining data of the display image, storing, in the storage, data of a superimposition image and data of a superimposition area for the superimposition image in the display image, wherein the superimposition area has been defined depending on the superimposition image, superimposing the superimposition image on the superimposition area in the display image, transmitting data of the display image which is superimposed with the superimposition image to the user computer, receiving, from the user computer, position data which indicates a position in the display image which is superimposed with the superimposition image, and determining whether the position is within the superimposition area.

According to a second aspect of the present invention, there is provided a data transmission system which includes: a server computer which transmits data of a web page, wherein the server computer is connected to a communication network, a client computer which receives data of the web page, wherein the client computer is connected to the communication network, and a data transmission apparatus which transmits, in response to a request of obtaining data of the display image from the client computer, data of the display image to be displayed on the web page, wherein the data transmission apparatus is connected to the communication network. The client computer includes: an input unit which receives position data which indicates a position, where a user has operated, in a display image which is superimposed with a superimposition image, and a position transmitter which transmits the position data. The data transmission apparatus includes: a reader which reads data of a display image which is stored in a storage on receiving the request of obtaining data of the display image, a storer which stores, in the storage, data of a superimposition image and data of a superimposition area for the superimposition image in the display image, wherein the superimposition area has been defined depending on the superimposition image, a superimposer which superimposes the superimposition image on the superimposition area in the display image, a transmitter which transmits data of the display image which is superimposed with the superimposition image to the client computer, a receiver which receives the position data which is transmitted from the client computer, and a determiner which determines whether the position is within the superimposition area.

According to a third aspect of the present invention, there is provided a data transmission apparatus which transmits data of a display image to be displayed on a web page to a client computer. The data transmission apparatus includes: a request receiver which receives a request of obtaining data of a display image, a display image reader which reads data of the display image which is stored in a storage on receiving the request of obtaining data of a display image, a storer which stores, in the storage, data of a superimposition image and data of a superimposition area for the superimposition image in the display image, wherein the superimposition area has been defined depending on the superimposition image, a superimposer which superimposes the superimposition image on the superimposition area in the display image, a transmitter which transmits data of the display image which is superimposed with the superimposition image to the client computer, a data receiver which receives, from the client computer, position data which indicates a position in the display image which is superimposed with the superimposition image, and a determiner which determines whether the position is within the superimposition area.

The data transmission apparatus may further include a counter which counts number of times of determinations in which the position is determined as being within the superimposition area.

The storage of the data transmission apparatus may further store a history of results of the determinations, and the data transmission apparatus may further include a fraud determiner which determines a fraudulent operation on the basis of the history of results of the determinations which is stored in the storage.

The storage of the data transmission apparatus may store data of multiple superimposition images and data of superimposition areas, and the data transmission apparatus may further include a superimposition data reader which reads data of a superimposition image which is selected randomly or regularly and a superimposition area which is corresponding to the selected superimposition image from the storage.

The data transmission apparatus may further include a superimposition image generator which generates the superimposition image, wherein the storage stores data of the superimposition image which is generated by the superimposition image generator.

The superimposition image generator of the data transmission apparatus may generate a superimposition image which has a size that is determined in accordance with a size of the display image which is stored in the storage.

The superimposition image generator of the data transmission apparatus may generate a superimposition image which has color data that is determined in accordance with color data of the display image which is stored in the storage.

The data transmission apparatus may further include: an extractor which extracts a contour image of the superimposition image, and a contour superimposer which superimposes the contour image or associated image of the contour image on the display image which is superimposed with the superimposition image.

The superimposition image of the data transmission apparatus may include an image of characters which prompts operations on the superimposition image.

The data transmission apparatus may further include a character superimposer which superimposes an associated image of the image of characters on the display image.

The data transmission apparatus may further includes: an associated image generator which generates an associated image of the superimposition image, wherein the associated image has a shape or color which is different from the superimposition image, and an associated image superimposer which superimposes the associated image on the display image.

The superimposition image generator of the data transmission apparatus may generate the superimposition image by changing a coefficient which is stored in the storage.

The superimposition image of the data transmission apparatus may be processed as to have color gradually changing from a center of the superimposition image toward a periphery thereof.

The superimposition image of the data transmission apparatus may be processed as to be transparent except for the image of characters.

The fraud determiner of the data transmission apparatus may determinate a fraudulent operation in accordance with a ratio of number of times of determinations in which the position is determined as being within the superimposition area to a total number of determinations of whether the position is within the superimposition area.

The data transmission apparatus may further include a scale determiner which determines a scale on the basis of a size of the superimposition area and a size of the display image, wherein the fraud determiner determinates a fraudulent operation on the basis of the scale and the ratio.

The storage of the data transmission apparatus may further store a series of position data which is received by the data receiver and a model of position which includes multiple position data, and the data transmission apparatus may further include: a correlation determiner which determines a degree of correlation on the basis of the series of position data and the model of position, and a fraud determiner which determines a fraudulent operation in accordance with the degree of correlation.

The storage of the data transmission apparatus may further store a series of position data which is received by the data receiver, and the data transmission apparatus may further include a fraud determiner which determines a fraudulent operation on the basis of degree of dispersion of the series of position data.

According to a fourth aspect of the present invention, there is provided a computer readable storage medium which stores a program of instructions to a computer for executing a data transmission method for transmitting data of an image to be displayed on a web page, wherein the computer is capable of communicating with a user computer. The data transmission method includes the steps of: reading data of a display image which is stored in a storage on receiving a request of obtaining data of the display image, storing, in the storage, data of a superimposition image and data of a superimposition area for the superimposition image in the display image, wherein the superimposition area has been defined depending on the superimposition image, superimposing the superimposition image on the superimposition area in the display image, transmitting data of the display image which is superimposed with the superimposition image to the user computer, receiving, from the user computer, position data which indicates a position in the display image which is superimposed with the superimposition image, and determining whether the position is within the superimposition area.

### BRIEF DESCRIPTION OF THE DRAWINGS

FIG. 1 is a schematic diagram illustrating an overview of an image data transmission system;

FIG. 2 is a block diagram illustrating a hardware configuration of a personal computer of a user and a web server according to a first embodiment of the present invention;

FIG. 3 is a block diagram illustrating a hardware configuration of an advertisement server according to a first embodiment of the present invention;

FIG. 4 is a diagram illustrating a record layout of an advertisement image DB according to a first embodiment of the present invention;

FIG. 5 is a diagram illustrating a record layout of a superimposition image DB according to a first embodiment of the present invention;

FIGS. 6A and 6B are schematic views each showing an image resulting from superimposing a superimposition image on a superimposition area in an advertisement image according to a first embodiment of the present invention;

FIG. 7 is a diagram illustrating a record layout of a transmission history DB according to a first embodiment of the present invention;

FIG. 8 is schematic view showing a look and feel of a content and an advertisement image superimposed with a superimposition image displayed on a browser window according to a first embodiment of the present invention;

FIG. 9 is a diagram illustrating a record layout of a history storage according to a first embodiment of the present invention;

FIG. 10 is a schematic view showing an advertisement image superimposed with a superimposition image according to a first embodiment of the present invention;

FIGS. 11 to 13 are diagrams illustrating a flowchart of a procedure for a validity determination processing according to a first embodiment of the present invention;

FIG. 14 is a block diagram illustrating a hardware configuration of an advertisement server according to a second embodiment of the present invention;

FIG. 15 is a diagram illustrating a record layout of a base rate storage according to a second embodiment of the present invention;

FIG. 16 is a diagram illustrating a record layout of a history storage according to a second embodiment of the present invention;

FIG. 17 is a diagram illustrating a flowchart of a procedure for identifying a fraudulent operation using software according to a second embodiment of the present invention;

FIG. 18 is a diagram illustrating a record layout of a superimposition image DB according to a third embodiment of the present invention for storing data of generated superimposition images and data of generated superimposition areas;

FIG. 19 is a diagram illustrating a record layout of a base rate storage according to a third embodiment of the present invention;

FIG. 20 is a diagram illustrating a flowchart of a procedure for generating a superimposition image and a superimposition area according to a third embodiment of the present invention;

FIGS. 21A and 21B are schematic views each showing an advertisement image superimposed with a superimposition image according to a fourth embodiment of the present invention;

FIG. 22 is a diagram illustrating a flowchart of a procedure for coloring processing according to a fourth embodiment of the present invention;

FIG. 23 is a schematic view showing an advertisement image superimposed with a superimposition image performed gradation processing according to a fourth embodiment of the present invention;

FIG. 24 is a diagram illustrating a flowchart of a procedure for the gradation processing according to a fourth embodiment of the present invention;

FIG. 25 is a schematic view showing an advertisement image superimposed with images associated with a superimposition image according to a fifth embodiment of the present invention;

FIG. 26 is a diagram illustrating a flowchart of a procedure for generating an associated image according to a fifth embodiment of the present invention;

FIG. 27 is a schematic view showing an advertisement image superimposed with an associated image of characters according to a fifth embodiment of the present invention;

FIG. 28 is a diagram illustrating a flowchart of a procedure for generating an associated image according to a fifth embodiment of the present invention;

FIG. 29 is a schematic view showing an advertisement image superimposed with associated images according to a fifth embodiment of the present invention;

FIG. 30 is a diagram illustrating a flowchart of a procedure for generating an associated image according to a fifth embodiment of the present invention;

FIG. 31 is a schematic view showing an advertisement image superimposed with a superimposition image of a geometric graphics according to a sixth embodiment of the present invention;

FIG. 32 is a diagram illustrating a flowchart of a procedure for generating a superimposition image of a geometric graphics according to a sixth embodiment of the present invention;

FIG. 33 is a block diagram illustrating a hardware configuration of an advertisement server according to a seventh embodiment of the present invention;

FIG. 34 is a diagram illustrating a record layout of a model storage according to a seventh embodiment of the present invention;

FIG. 35 is a schematic view showing trajectories of clicked coordinates in accordance with models according to a seventh embodiment of the present invention;

FIGS. 36 and 37 are diagrams illustrating a flowchart of a procedure for fraud identifying processing according to a seventh embodiment of the present invention;

FIGS. 38A and 38B are diagrams illustrating a flowchart of a procedure for the fraud identifying processing according to an eighth embodiment of the present invention;

FIG. 39 is a block diagram illustrating a hardware configuration of an advertisement server according to a ninth embodiment of the present invention;

FIG. 40 is a diagram illustrating examples of commands described in web page data according to a first embodiment of the present invention;

FIG. 41 is a diagram illustrating examples of expressions for determining validity of a clicked coordinate according to a first embodiment of the present invention; and

FIG. 42 is a diagram illustrating an example of an expression for determining a degree of correlation between a series of clicked coordinates and a series of coordinates specified by an expression for a model stored in a model storage according to a first embodiment of the present invention.

### DESCRIPTION OF THE PREFERRED EMBODIMENTS

Preferred embodiments of the present invention will now be described with reference to the accompanying drawings.

### First Embodiment

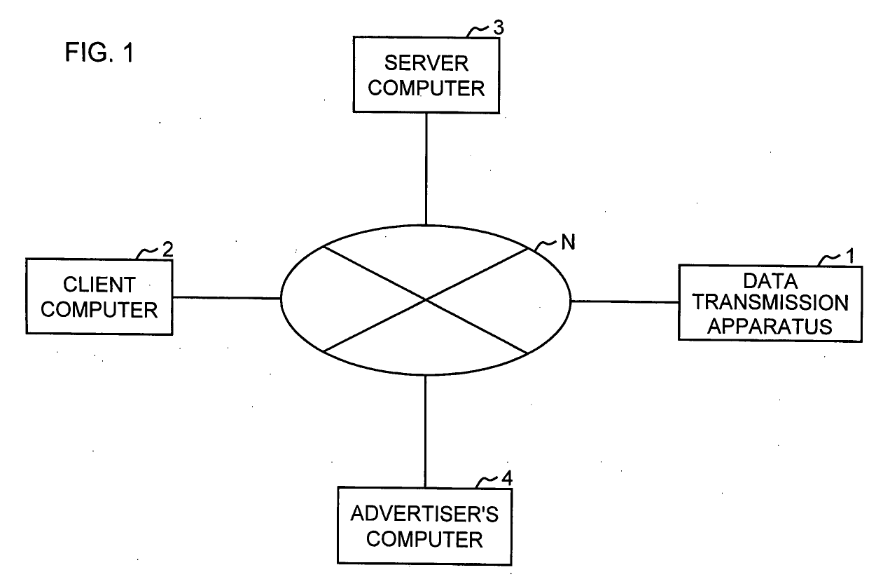

FIG. 1 is a schematic diagram illustrating an overview of an image data transmission system. The image data transmission system includes a data transmission apparatus 1, a client computer 2, a server computer 3, an advertiser's computer 4, and a communication network N such as the Internet. The data transmission apparatus 1, the client computer 2, the server computer 3, and the advertiser's computer 4 are interconnected through the communication network N to transmit/receive various types of information including HTML (hyper text markup language) files in conformity to an HTTP (hyper text transfer protocol) or the like. It is assumed in the following description that the client computer 2 is a personal computer 2, the server computer 3 is a web server 3, the data transmission apparatus 1 is an advertisement server 1, and the advertiser's computer 4 is a personal computer 4 of an advertiser.

A user launches a browser of the personal computer 2 and accesses the web server 3 to download web page data. A command for obtaining, from the advertisement server 1, data of a display image (hereinafter referred to as an “advertisement image”) that serves as a banner advertisement image is written in the web page data to display the advertisement image in addition to content downloaded from the web server 3. In accordance with the command, the personal computer 2 issues a request for the advertisement image data to the advertisement server 1. The advertisement server 1 superimposes a superimposition image on a superimposition area in the advertisement image and transmits data of the advertisement image superimposed with the superimposition image to the personal computer 2.

When the user clicks on the superimposition image on the superimposition area in the advertisement image displayed on the browser window, the user can jump from the page displayed to a page of the advertiser. On the other hand, the personal computer 2 transmits data of a clicked position to the advertisement server 1. The advertisement server 1 determines whether the clicked position exists within the superimposition area. On the basis of the history data of the determination result, the advertisement server 1 also determines whether the clicking is valid. The advertisement server 1 then transmits, to the personal computer 4 of the advertiser, billing information according to number of valid clicks on the advertisement image.

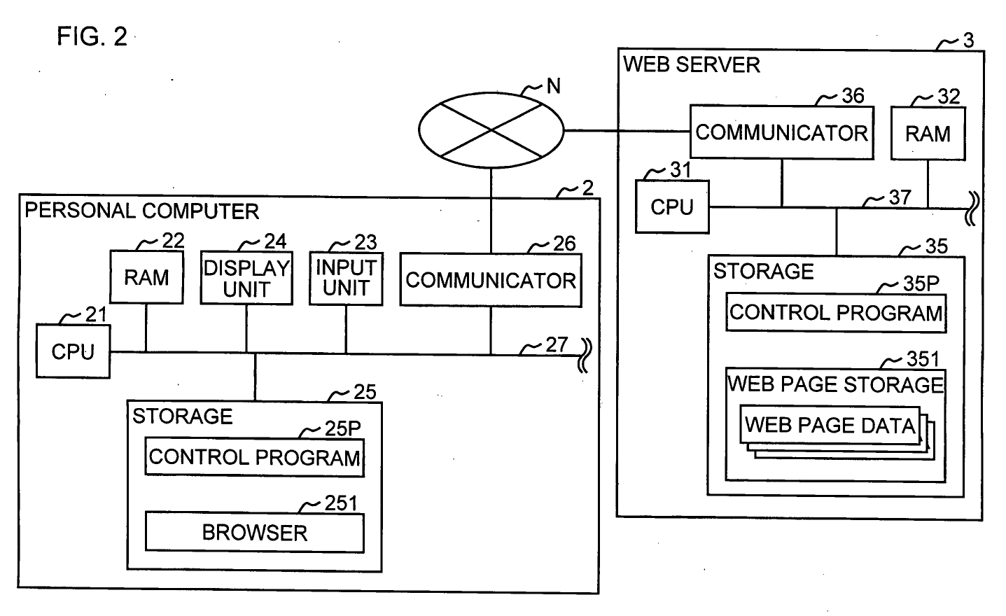

FIG. 2 is a block diagram illustrating a hardware configuration of a personal computer of a user and a web server according to a first embodiment of the present invention. The personal computer 2 of the user will be described first. The personal computer 2 includes a CPU (central processing unit) 21 that serves as a controller, a RAM (random access memory) 22, an input unit 23, a display unit 24, a storage 25 and a communicator 26. The CPU 21 is connected to the hardware units of the personal computer 2 through a bus 27 to control the hardware units and to execute various software functions in accordance with a control program 25P stored in the storage 25.

The display unit 24 is, for example, a liquid crystal display. The input unit 23 includes a keyboard and a mouse. The communicator 26 includes a modem, a LAN (local area network) card, or the like and transmits/receives information to/from the web server 3 in conformity to an HTTP or the like. The storage 25 includes, for example, a hard disk and stores a browser 251, such as Internet Explore®.

For accessing the web server 3, the user launches the browser 251 via the input unit 23 and inputs the URL (uniform resource locator) of the web server 3. As a result, a top page of the web server 3 is displayed on the display unit 24.

The web server 3 will be described next. The web server 3 includes a CPU 31 serving as a controller, a RAM 32, a communicator 36, and a storage 35. The CPU 31 is connected to the hardware units of the web server 3 through a bus 37 to control the hardware units and to execute various software functions in accordance with a control program 35P stored in the storage 35.

The communicator 36 includes, for example, a gateway serving as a firewall. The storage 35 stores a web page storage 351 in addition to the above-mentioned control program 35P. The web page storage 351 hierarchically stores multiple pieces of web page data. Web page data is written in, for example, an HTML format and have spaces for attaching advertisement image data in addition to content provided by the web server 3. In the web page data, information including a URL of the advertisement server 1 and commands for causing the personal computer 2 to obtain the advertisement image data from the advertisement server 1 is described in association with the spaces for attaching advertisement image data.

Information for transmitting, to the advertisement server 1, position data (hereinafter, also referred to as a “clicked coordinate”) input by the user via the input unit 23 is also written in the web page data. Specifically, a server-side clickable map function described in the browser 251 is used. In this case, a command <a href=“xyz.cgi”><img src=“map.gif” border=0 ismap></a> and a transmission destination URL (http://adddress of advertisement server 1/xyz.cgi?x,y) are written in the web page data. When a clicked coordinate (x, y) is input via the input unit 23, the CPU 21 receives the input clicked coordinate (x, y) and transmits the clicked coordinate (x, y) to the advertisement server 1 by referring to the written URL. The advertisement server 1 receives the clicked coordinate (x, y) as parameters for xyz.cgi. By using a command $ENV{‘QUERY_STRING’}, xyz.cgi of the advertisement server 1 extracts the clicked coordinate (x, y).

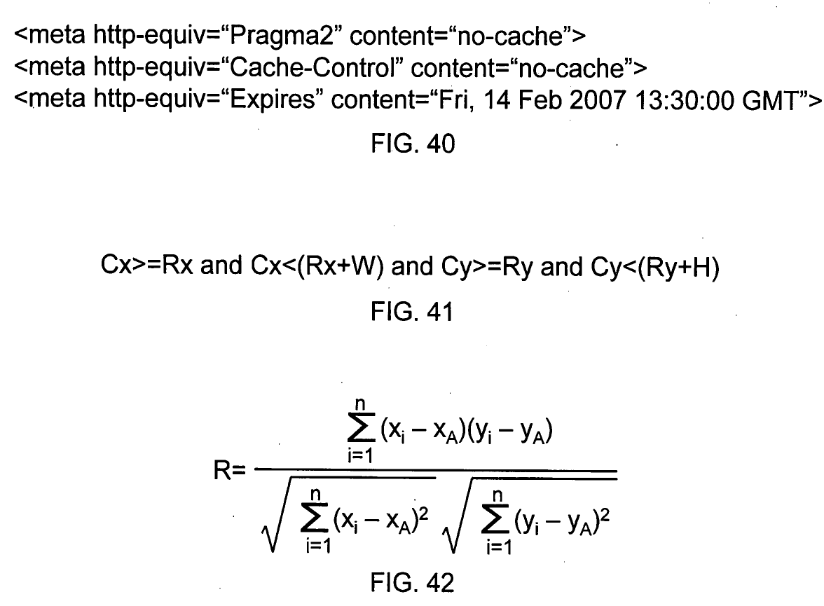

In addition, information for prohibiting the personal computer 2 from caching web page data is written in the web page data. The information is aimed to prevent the position of a superimposition image from being fixed. For example, the commands shown in FIG. 40 are written between <head> and </head> in the web page data.

The CPU 31 of the web server 3 reads web page data stored in the web page storage 351 and transmits the read web page data to the personal computer 2. The personal computer 2 displays the web page on a browser window. A space for attaching advertisement image is displayed on the browser window in addition to content provided by the web server 3. The CPU 21 issues a request for obtaining advertisement image data to the advertisement server 1 to obtain advertisement image data for the space.

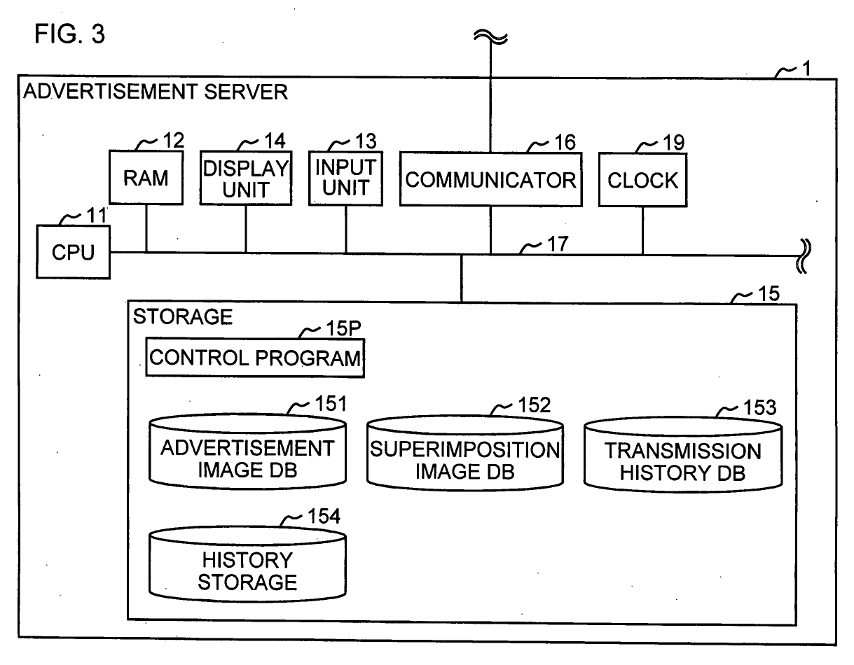

FIG. 3 is a block diagram illustrating a hardware configuration of an advertisement server according to a first embodiment of the present invention. The advertisement server 1 includes a CPU 11 serving as a controller, a RAM 12, a display unit 14, an input unit 13, a clock 19, a communicator 16, and a storage 15. The CPU 11 is connected to the hardware units of the advertisement server 1 through a bus 17 to control the hardware units and to execute various software functions in accordance with a control program 15P stored in the storage 15.

The communicator 16 includes, for example, a gateway serving as a firewall. The display unit 14 is, for example, a liquid crystal display. The input unit 13 includes a keyboard and a mouse. The clock 19 outputs data of date and time to the CPU 11. The storage 15 includes, for example, a hard disk. The storage 15 stores an advertisement image DB (database) 151, a superimposition image DB 152, a transmission history DB 153, and a history storage 154 in addition to the above-mentioned control program 15P. The CPU 11 executes processing, such as storing and searching for necessary information, by running queries in a schema where keys of fields of the advertisement image DB 151, the superimposition image DB 152, the transmission history DB 153, and the history storage 154 are associated, using an access interface such as an SQL (structured query language) in accordance with database formats. Although the advertisement image DB 151, the superimposition image DB 152, the transmission history DB 153, and the history storage 154 are stored in the storage 15 in the first embodiment, a portion or all of the databases may be alternatively stored in a database server (not shown).

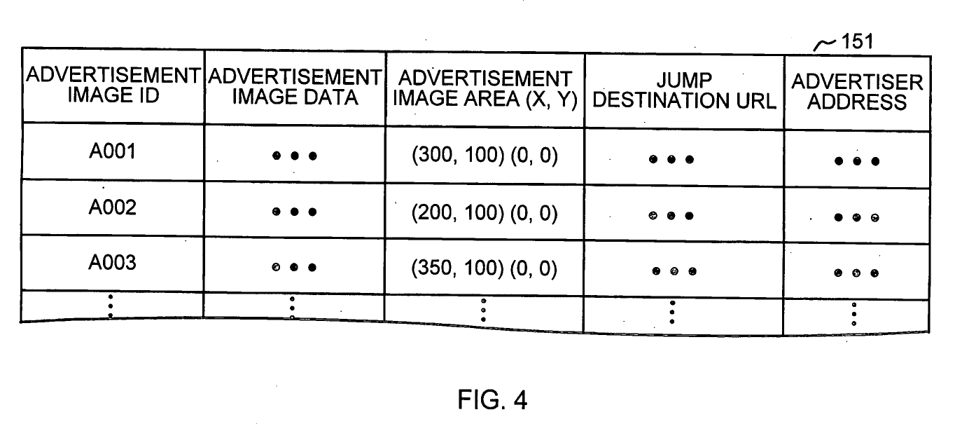

FIG. 4 is a diagram illustrating a record layout of an advertisement image DB according to a first embodiment of the present invention. The advertisement image DB 151 stores advertisement image data supplied from each advertisers and various types of information regarding the advertisement images. The advertisement image DB 151 has “advertisement image ID” fields, “advertisement image data” fields, “advertisement image area” fields, “jump destination URL” fields, and “advertiser address” fields. An advertisement image ID is a unique ID for identifying each advertisement image. The “advertisement image data” fields store advertisement image data in association with advertisement image IDs in, for example, a JPEG (Joint Photographic Experts Group) or a Flash® format. Display areas (X, Y) for the advertisement image data are stored in the “advertisement image area” fields in an x and y coordinate system.

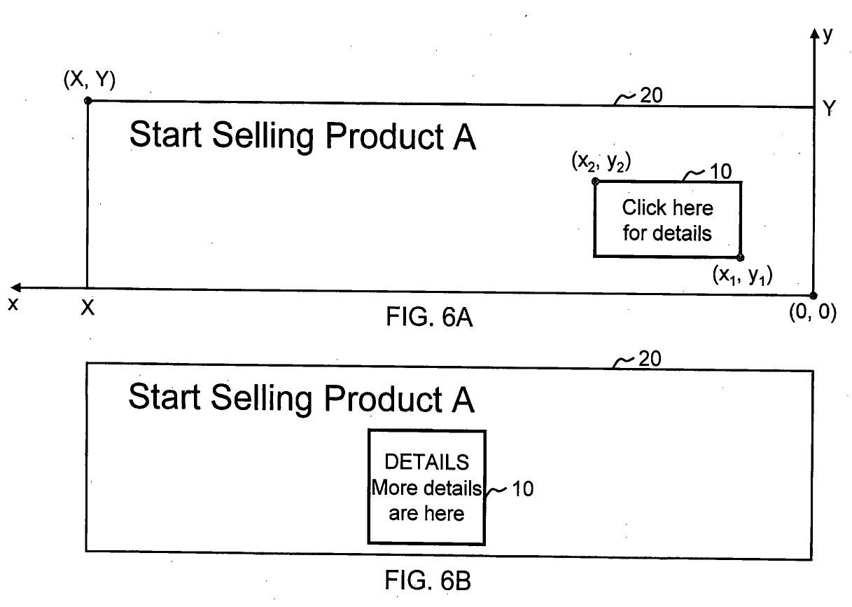

As described below and shown in FIG. 6A, a lower right coordinate of an advertisement image is an origin coordinate (0, 0), the horizontal direction is indicated by an x-axis, the vertical direction is indicated by a y-axis, the left side of the x-axis is a positive direction, and the upper side of the y-axis is a positive direction. The lower right coordinate (0, 0) and the upper left coordinate (X, Y) of the advertisement image are stored in “advertisement image area” fields. When the display area of an advertisement image has a rectangular shape, it is defined by the lower right coordinate (0, 0) and the upper left coordinate (X, Y). For example, since an advertisement image with advertisement image ID “A001” has lower right coordinate (0, 0) and upper left coordinate (300, 100), it can be understood that the advertisement image is a rectangular image having a width of 300 and a height of 100. Although the advertisement image is described as having a rectangular shape in the first embodiment, it may have another shape, for example, a square shape, a triangular shape, a circular shape, an oval shape, a star shape, and so on.

The “jump destination URL” fields store URLs of jump destinations in association with the advertisement image IDs. The “advertiser address” fields store electronic mail addresses of each of advertisers that provide advertisement image data, IP addresses of the personal computers 4 of the advertisers, and so on in association with the advertisement image IDs. The CPU 11 of the advertisement server 1 randomly or regularly selects advertisement image data stored in the advertisement image DB 151 and outputs the selected advertisement image data. The advertisement image data may be selected so that advertisement image data are equally output. Alternatively, selection rates may be stored in association with advertisement image IDs so that the advertisement image data are selected in accordance with the selection rates. For example, a selection rate “80%” is stored for the advertisement image ID “A001” and a selection rate “10%” is stored for each of other advertisement image IDs “A002” and “A003”. The CPU 11 may select advertisement image data in accordance with the stored selection rates.

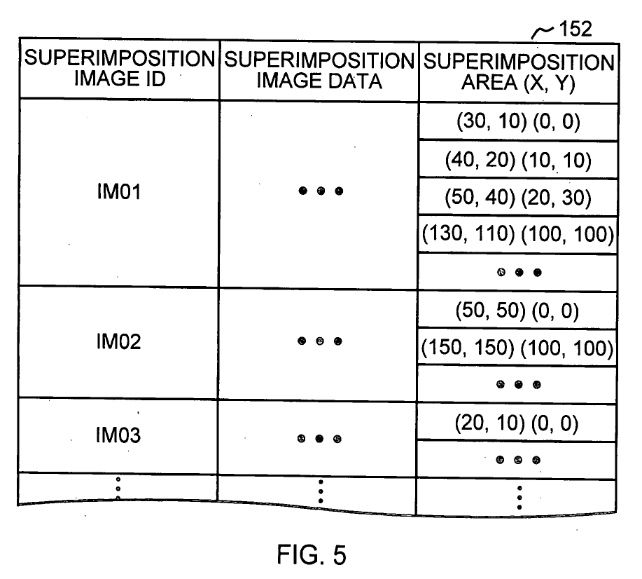

FIG. 5 is a diagram illustrating a record layout of a superimposition image DB according to a first embodiment of the present invention. The superimposition image DB 152 has “superimposition image ID” fields, “superimposition image data” fields, and “superimposition area” fields. The “superimposition image ID” fields store unique ID for identifying each superimposition image. The “superimposition image data” fields store image data in a JPEG format or the like in association with superimposition image IDs. A superimposition image is an image to be superimposed on part of an advertisement image, and in the first embodiment, multiple superimposition images including superimposition images with superimposition image IDs “IM01”, “IM02”, and “IM03” are provided.

In the “superimposition area” fields, data of multiple superimposition areas are stored for each superimposition image. The superimposition areas are used to specify areas in an advertisement image where the superimposition images are to be superimposed, and in the first embodiment, the coordinates of positions where rectangular superimposition images are to be superimposed on rectangular superimposition areas are stored in the “superimposition area” fields in an x and y coordinate system. For example, position coordinates (40, 20) and (10, 10) are stored for a superimposition area. The position coordinates represent a rectangular superimposition area defined by four points expressed by lower right coordinate (10, 10), upper right coordinate (10, 20), lower left coordinate (40, 10), and upper left coordinate (40, 20).

FIGS. 6A and 6B are schematic views each showing an image resulting from superimposing a superimposition image on a superimposition area in an advertisement image according to a first embodiment of the present invention. More specifically, FIG. 6A shows an image resulting from superimposing a rectangular superimposition image (IM01) on a superimposition area in an advertisement image. In FIGS. 6A and 6B, reference numeral “20” indicates advertisement images and reference numeral “10” indicates superimposition images. As described above, in the x and y coordinate system, the lower right coordinate of the advertisement image 20 is an origin coordinate (0, 0), the horizontal direction is indicated by an x-axis, the vertical direction is indicated by a y-axis, the left side of the x-axis is a positive direction, and the upper side of the y-axis is a positive direction. On the advertisement image 20, the area of the advertisement image 20 is defined by data of an advertisement image area stored in the advertisement image DB 151, and in this example, the advertisement image 20 is a rectangular image defined by lower right coordinate (0, 0), lower left coordinate (X, 0), upper right coordinate (0, Y), and upper left coordinate (X, Y). On the advertisement image 20, characters, such as “Start Selling Product A” in this example, as well as a product image (not shown) are displayed as an image. On the advertisement image 20, not only the characters but also pictures, graphics, and so on may be displayed.

An area for superimposition is determined in accordance with data of a superimposition area stored in the superimposition image DB 152. The superimposition image 10 is superimposed on an area defined by a superimposition area, that is, an area expressed by lower right coordinate (x₁, y₁) and upper left coordinate (x₂, y₂). In the example of FIG. 6A, the superimposition area has a rectangular shape defined by lower right coordinate (10, 10), upper right coordinate (10, 20), lower left coordinate (40, 10), and upper left coordinate (40, 20). The CPU 11 sets the superimposition image data “IM01” on the superimposition area. Although data of multiple superimposition areas are pre-stored in the superimposition image DB 152 in the first embodiment for ease of description, the present invention is not limited thereto. For example, the arrangement may be such that, after superimposing the superimposition image 10 on the advertisement image 20, an area where the superimposition image 10 exists is regarded as a superimposition area and data of the superimposition area is stored in the superimposition image DB 152 in association with the superimposition image 10. The superimposition image 10 may have substantially the same size as the superimposition area. The superimposition image 10 may include information regarding characters for prompting the user to perform operation on the superimposition image 10. The information may be displayed as an image with characters “Click here for details” or the like, as shown in FIG. 6A. When the user clicks on the superimposition image 10 in the superimposition area by using the input unit 23 in response to the characters, the clicked coordinate (x, y) is transmitted to the advertisement server 1.

When the clicked coordinate exists within a superimposition area defined by lower right coordinate (10, 10), upper right coordinate (10, 20), lower left coordinate (40, 10), and upper left coordinate (40, 20), the CPU 11 of the advertisement server 1 determines that the clicking is valid. On the other hand, when the clicked coordinate exists within an area of the advertisement image 20 that is defined by the lower right coordinate (0, 0), upper right coordinate (X, 0), lower left coordinate (0, Y), and upper left coordinate (X, Y) and that does not exist within the superimposition area, the CPU 11 of the advertisement server 1 determines that the clicking is invalid.

FIG. 6B shows an image resulting from superimposing a square superimposition image 10 (IM02) on a superimposition area in an advertisement image 20. In FIG. 6B, compared to the superimposition image shown in FIG. 6A, a square superimposition image 10, which is different in shape, is superimposed on a different superimposition area. The CPU 11 selects data of one superimposition image 10 from the superimposition image DB 152 randomly or in accordance with a predetermined rule. The CPU 11 then superimposes data of the selected superimposition image 10 on the superimposition area, as shown in FIG. 6B. The predetermined rule may be, for example, a rule in which numbers of selected data of each superimposition image 10 are equal or a rule in which each superimposition image is weighted and data of a superimposition image is selected in accordance with the magnitude of the weight. Similarly, data of the superimposition area may also be selected in accordance with a rule in which the numbers of selected data of each superimposition area are equal or a rule in which each superimposition area is weighted and data of a superimposition area is selected in accordance with the magnitude of the weight.

Although an example of an image of characters for prompting the user to click on the superimposition image 10 has been described in the first embodiment, an arrow mark and so on as well as the characters may also be included in the image. Although data of multiple superimposition images 10 and data of multiple superimposition areas for each of the multiple superimposition images 10 are pre-stored and randomly or regularly read and displayed in the first embodiment, number of superimposition images 10 and number of superimposition areas may be one. The arrangement may also be such that data of one superimposition image 10 and data of multiple superimposition areas are pre-stored, data of one of the superimposition areas is randomly or regularly read, and the superimposition image 10 is superimposed on the superimposition area. In addition, the arrangement may be such that data of multiple superimposition images 10 and data of one superimposition area are pre-stored. In this case, data of one of the superimposition images is randomly or regularly read and the superimposition image 10 is superimposed on the superimposition area.

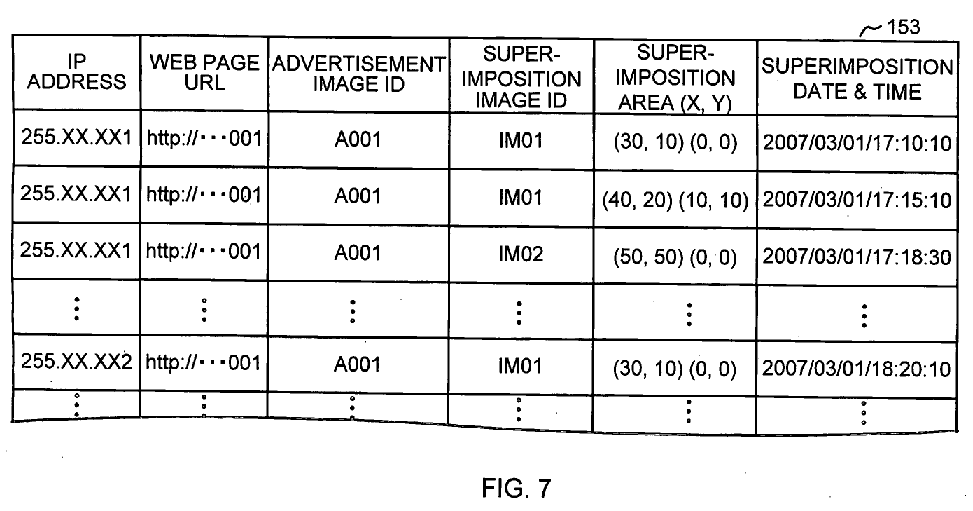

The CPU 11 transmits data of the advertisement image 20 superimposed with the superimposition image 10 via the communicator 16 to the personal computer 2 that issued a request. The CPU 11 stores history data of the superimposition processing and the transmission processing in the transmission history DB 153. FIG. 7 is a diagram illustrating a record layout of a transmission history DB according to a first embodiment of the present invention. The transmission history DB 153 has “IP address” fields, “web page URL” fields, “advertisement image ID” fields, “superimposition image ID” fields, “superimposition area” fields, and “superimposition date & time” fields.

The “IP address” fields store IP addresses of personal computers 2 that issued requests for obtaining data of advertisement images 20. The “web page URL” fields store URLs of web pages. The “advertisement image ID” fields store the advertisement image IDs of advertisement images 20 for which the obtaining requests were issued. The “superimposition image ID” fields store the IDs of superimposition images 10 superimposed on advertisement images 20. The “superimposition area” fields store coordinate values used for superimposing the superimposition images 10 on the advertisement image 20. The “superimposition date & time” fields store data of date and time when the superimposition images 10 were superimposed on superimposition areas in the advertisement images 20. A sub-second unit of time of the superimposition date & time is omitted for convenience of description.

The above-described pieces of information are stored in accordance with the superimposition date & time stored in the “superimposition date & time” fields. For example, at 17:10:10 on Mar. 1 in 2007, the CPU 11 superimposes data of a superimposition image 10 with superimposition image ID “IM01” which is read from the superimposition image DB 152 on a superimposition area (30, 10) (0, 0) which is read from the advertisement image DB 151 in an advertisement image 20 with advertisement image ID “A001” which is also read from the advertisement image DB 151. The CPU 11 then transmits to a personal computer 2 with IP address “255.XX.XX1” data of the advertisement image 20 superimposed with superimposition image 10, the superimposition date & time for identifying the superimposed image, and a URL that serves as a jump destination when the superimposition image 10 is clicked. Instead of the superimposition date & time, a unique ID may be transmitted. The advertisement image 20 superimposed with superimposition image 10 in addition to content transmitted from the web server 3 is displayed on a browser window of the personal computer 2 as a web page corresponding to URL “http:// . . . 001”.

When the superimposition image 10 is superimposed on the advertisement image 20, the CPU 11 stores the superimposition date & time in the transmission history DB 153 on the basis of data of date and time output from the clock 19. After transmitting data of the advertisement image 20 superimposed with superimposition image 10, the CPU 11 stores, in the transmission history DB 153, the above-described superimposition image ID, data of the superimposition area, the advertisement image ID, the web page URL, and the IP address of the personal computer 2 as the transmission destination in association with the superimposition date & time. A command for a server-side clickable map function for transmitting the clicked coordinate to the advertisement server 1 may be transmitted from the CPU 11 of the advertisement server 1 to the personal computer 2 in conjunction with data of the advertisement image 20 superimposed with the superimposition image 10. In addition, a command for prohibiting the personal computer 2 from caching data of the advertisement image 20 superimposed with the superimposition image 10 may be transmitted from the CPU 11 of the advertisement server 1 to the personal computer 2 in conjunction with data of the advertisement image 20 superimposed with the superimposition image 10.

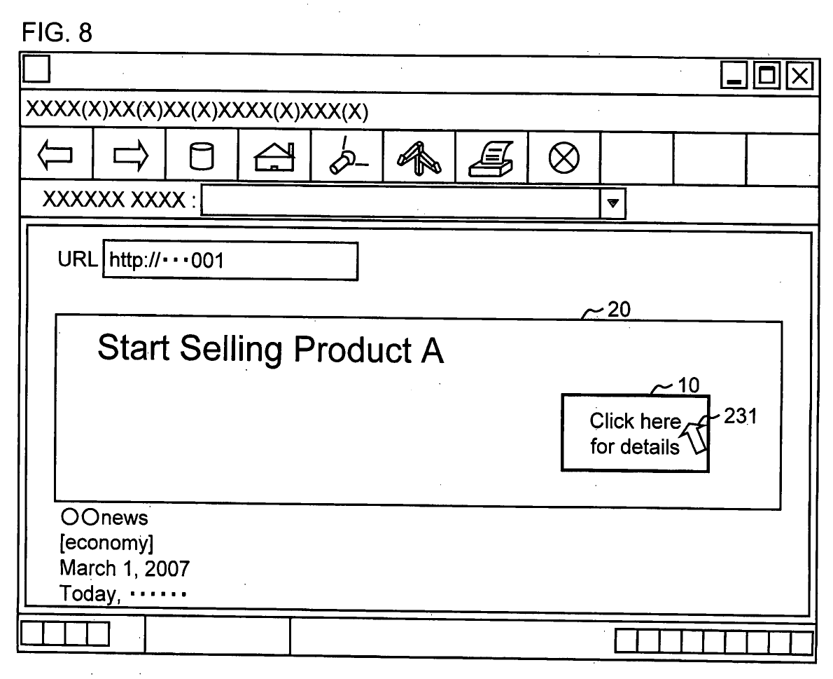

FIG. 8 is schematic view showing a look and feel of content and an advertisement image superimposed with a superimposition image displayed on a browser window according to a first embodiment of the present invention. The CPU 21 of the personal computer 2 displays content transmitted from the web server 3 on the browser window. In the example in FIG. 8, economic news is displayed as the content. The CPU 21 displays data of the advertisement image 20 superimposed with the superimposition image 10, transmitted from the advertisement server 1 in response to an obtaining request, in an area defined in an HTML format by the web server 3. As a result, as shown in FIG. 8, the advertisement image 20 superimposed with the superimposition image 10 in addition to the content are displayed on part of the web page. The user operates a pointer 231 via the input unit 23 to perform a click operation at a desired clicked coordinate. The CPU 21 receives the clicked coordinate input via the input unit 23 and transmits the clicked coordinate to the advertisement server 1 via the communicator 26. The coordinate system for the clicked coordinate is the same as the one shown in FIG. 6A.

When a user clicks on the superimposition image 10 via the input unit 23, the CPU 21 of the personal computer 2 transmits an IP address of the personal computer 2, the web page URL, the advertisement image ID, the superimposition image ID, the superimposition date & time, and a clicked coordinate to the advertisement server 1. The web page URL, the advertisement image ID, and the superimposition image ID do not necessarily have to be transmitted. When the user clicks on the advertisement image 20 via the input unit 23, the CPU 21 of the personal computer 2 also transmits the IP address of the personal computer 2, the web page URL, the advertisement image ID, the superimposition image ID, the superimposition date & time, and the clicked coordinate to the advertisement server 1. In the superimposition area where the superimposition image 10 is superimposed, a URL of a jump destination is written as a hyperlink.

The CPU 21 accesses to the hyperlinked URL and displays content of the jump destination on a browser window. In the example of FIG. 8, content regarding product A is displayed. In the first embodiment, a hyperlink is provided in the superimposition area for the superimposition image 10. In this case, even when the user clicks on the advertisement image 20 via the input unit 23, the clicked coordinate is transmitted to the advertisement server 1 but the user can not jump from the page to the corresponding URL since the hyperlink of the jump destination is not provided in portions other than the superimposition area. However, the hyperlink may be set in not only the superimposition area for the superimposition image 10 but also the entire area of the advertisement image 20, so that when the user clicks on the advertisement image 20, the user can jump from the page to the hyperlinked URL.

The CPU 11 of the advertisement server 1 receives the IP address of the personal computer 2, the web page URL, the advertisement image ID, the superimposition image ID, the superimposition date & time, and the clicked coordinate via the communicator 16. On the basis of the transmitted superimposition date & time, the CPU 11 searches in the transmission history DB 153 to determine whether the transmitted clicked coordinate exists within a superimposition area. When the clicked coordinate exists within a superimposition area, the CPU 11 determines that the clicking is valid. When the clicked coordinate does not exist within a superimposition area, the CPU 11 determines that the clicking is invalid.

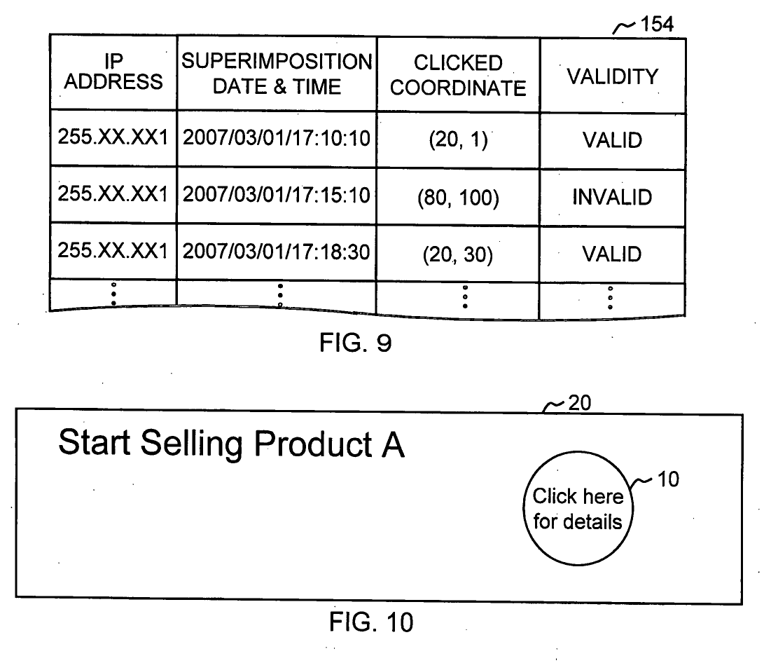

FIG. 9 is a diagram illustrating a record layout of a history storage according to a first embodiment of the present invention. After determining whether the clicked coordinate exists within the superimposition area, the CPU 11 stores the determination result in the history storage 154. The history storage 154 has “IP address” fields, “superimposition date & time” fields, “clicked coordinate” fields, and “validity” fields. The “IP address” fields store IP addresses of personal computers 2 that transmitted a clicked coordinate. The “superimposition date & time” fields store superimposition dates & times for identifying superimposition images 10, advertisement images 20, and superimposition areas which are used for the determination of validity.

The “clicked coordinate” fields store clicked coordinates, transmitted from the personal computers 2, in association with the IP addresses and the superimposition dates & times. The “validity” fields store information indicating whether the clicked coordinates are valid. For example, in the case of the superimposition date & time “at 17:10:10 on Mar. 1 in 2007”, since the superimposition area is (30, 10) (0, 0) (see FIG. 7) and the clicked coordinate is (20, 1) (see FIG. 9) that exists within the superimposition area, the CPU 11 stores “valid” in the “validity” field. On the other hand, in the case of the superimposition date & time “at 17:15:10 on Mar. 1 in 2007”, the superimposition area is (40, 20) (10, 10) and the clicked coordinate is (80, 100) that does not exist within the superimposition area. In this case, since the clicked coordinate that exists within an area of the advertisement image 20 and that does not exist within the superimposition area on which the superimposition image 10 is superimposed is input from the input unit 23 of the personal computer 2, the CPU 11 stores “invalid” in the “validity” field. The above-described scheme for storing data in the advertisement image DB 151, the superimposition image DB 152, the transmission history DB 153, and the history storage 154 is merely one example, and thus, various storage schemes may be employed depending on the design.

The above-described scheme for determining validity of the clicked coordinate is merely one example and another scheme described below may be employed. For example, it is assumed that an upper left coordinate of an advertisement image 20 is an origin coordinate (0, 0), the horizontal direction is indicated by an x-axis, the vertical direction is indicated by a y-axis, the right side of the x-axis is a positive direction, and the lower side of the y-axis is a positive direction, and that an upper left coordinate, a width, and a height of a superimposition image 10 are denoted by (Rx, Ry), W, and H, respectively. Upon receiving a clicked coordinate (Cx, Cy) from the personal computer 2, the CPU 11 determines that the clicked coordinate (Cx, Cy) is valid when it satisfies the expressions shown in FIG. 41. When the clicked coordinate (Cx, Cy) does not satisfy the expressions shown in FIG. 41, the CPU 11 determines that the clicked coordinate (Cx, Cy) is invalid.

A mask pattern corresponding to a superimposition area for a superimposition image 10 may be stored in the superimposition image DB 152. FIG. 10 is a schematic view showing an advertisement image superimposed with a superimposition image according to a first embodiment of the present invention. A circular superimposition image 10 is superimposed on a circular superimposition area in an advertisement image 20. In this case, the CPU 11 stores a mask pattern, that is, information indicating either “valid” or “invalid” for each coordinate value. For example, “1” indicating “valid” is stored, in the superimposition image DB 152, for a coordinate (50, 50) that exists within the superimposition area and “0” indicating “invalid” is stored for a coordinate (150, 100) that does not exist within the superimposition area. Upon receiving a clicked coordinate from the personal computer 2 in association with a superimposition date & time, the CPU 11 determines valid or invalid in accordance with whether a value corresponding to the clicked coordinate in the mask pattern is “1” or “0”.

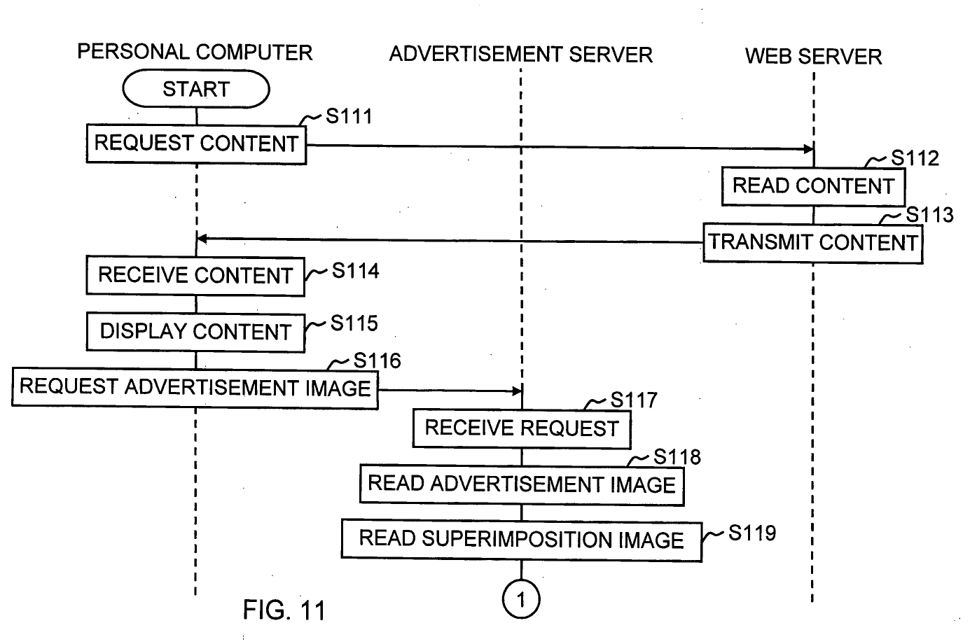

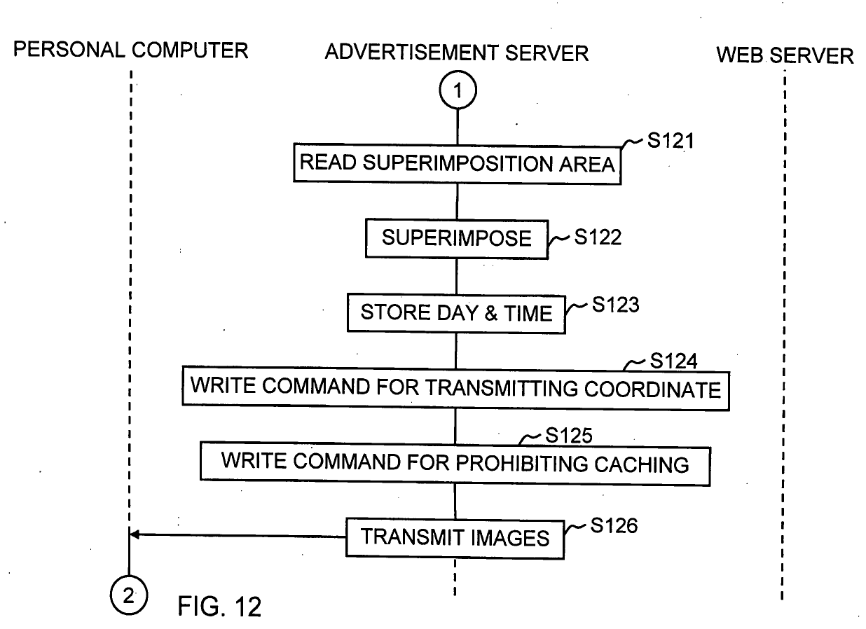

A procedure for a series of processing for the above-described hardware configuration will now be described with reference to a flowchart. FIGS. 11 to 13 are diagrams illustrating a flowchart of a procedure for a validity determination processing according to a first embodiment of the present invention. A user of the personal computer 2 launches the browser 251. The user then inputs the URL of the web server 3 via the input unit 23. In step S111, on the basis of the input URL, the CPU 21 issues a request for obtaining content to the web server 3. In step S112, the web server 3 reads the content of a web page from the web page storage 351. In step S113, the web server 3 transmits the read content to the personal computer 2. In step S114, the CPU 21 of the personal computer 2 receives the transmitted content.

In step S115, the CPU 21 displays the content on the browser window. In step S116, the CPU 21 issues a request for obtaining data of an advertisement image 20 to the advertisement server 1. In step S117, the CPU 11 of the advertisement server 1 receives the request for obtaining data of an advertisement image 20. In step S118, the CPU 11 reads data of a randomly selected advertisement image 20 from the advertisement image DB 151. The advertisement image 20 and so on is described below as being randomly selected. In step S119, the CPU 11 reads data of a randomly selected superimposition image 10 from the superimposition image DB 152. In step S121, the CPU 11 randomly selects data of one superimposition area corresponding to data of the selected superimposition image 10 from data of multiple superimposition areas stored in the superimposition image DB 152, and reads data of the selected superimposition area. Although, as described above, data of multiple superimposition areas are pre-stored in the superimposition image DB 152, the arrangement may also be such that the superimposition image 10 is superimposed on an arbitrary area in the advertisement image 20 and data of the area is stored as a superimposition area in the superimposition image DB 152 in association with the superimposition image 10.

In step S122, the CPU 11 superimposes the superimposition image 10 on the superimposition area in the advertisement image 20. In step S123, the CPU 11 stores the superimposition date & time, generated by referring to an output from the clock 19, in the transmission history DB 153 in association with the IP address, the web page URL, the advertisement image ID, the superimposition image ID, and data of the superimposition area. In step S124, the CPU 11 writes, for the advertisement image 20 superimposed with the superimposition image 10, a command for transmitting a clicked coordinate within the advertisement image 20 superimposed with the superimposition image 10 to the advertisement server 1. In step S125, the CPU 11 further writes, for the advertisement image 20 superimposed with the superimposition image 10, a command for prohibiting the personal computer 2 from caching the advertisement image 20 superimposed with the superimposition image 10.

In step S126, the CPU 11 transmits data of the advertisement image 20 superimposed with the superimposition image 10, a superimposition date & time, and a jump destination URL to the personal computer 2. In step S127, the CPU 21 of the personal computer 2 receives the transmitted data of advertisement image 20 superimposed with the superimposition image 10, the superimposition date & time, and the jump destination URL. In step S128, the CPU 21 receives a clicked coordinate input via the input unit 23. In step S129, in accordance with the command for transmitting a clicked coordinate to the advertisement server 1, the CPU 21 transmits the received clicked coordinate and a corresponding superimposition date & time.

Subsequent to step S129, the CPU 11 of the advertisement server 1 receives the clicked coordinate and the superimposition date & time. In step S134, on the basis of the received superimposition date & time, the CPU 11 reads data of a corresponding superimposition area from the transmission history DB 153. In step S135, the CPU 11 determines whether the received clicked coordinate exists within the superimposition area. Upon determining that the clicked coordinate exists within the superimposition area (Yes in step S135), the CPU 11 determines that the clicked coordinate is valid in step S137. Thereafter, the CPU 11 reads a jump destination URL corresponding to the advertisement image 20 from the advertisement image DB 151 and transmits the read jump destination URL to the personal computer 2 in step S138.

Upon receiving the jump destination URL, the CPU 21 of the personal computer 2 displays the web page of the jump destination on the browser window in step S139. On the other hand, upon determining that the clicked coordinate does not exist within the superimposition area (No in step S135), the CPU 11 determines that the transmitted clicked coordinate is invalid in step S136, and the steps S138 and S139 are skipped. As described above, even when the user clicks on an area in the browser window, located outside the superimposition area in the advertisement image 20, the CPU 21 may display the web page of the jump destination on the browser window by referring to the jump destination URL received in step S127. Lastly, in step S1310, the CPU 11 stores the validity in the history storage 154 in association with the IP address and the superimposition date & time.

### Second Embodiment

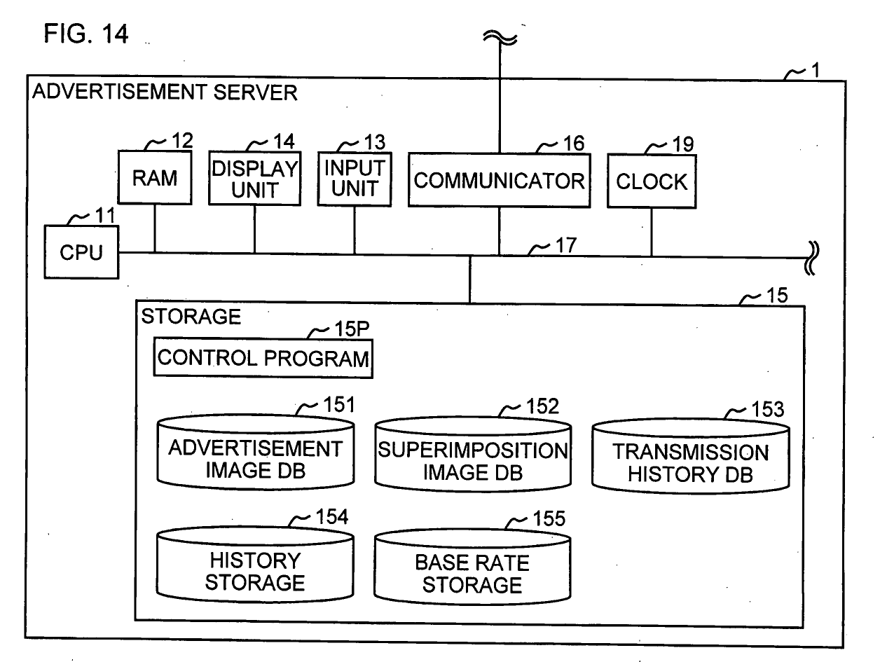

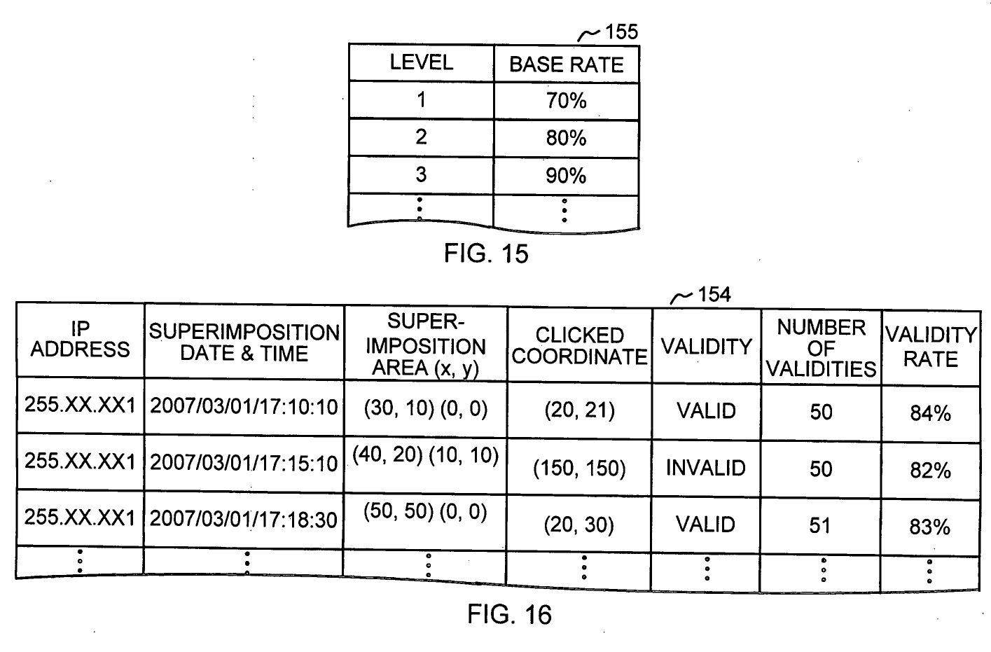

A second embodiment of the present invention relates to a scheme for identifying fraud using software for automatically performing click operations. FIG. 14 is a block diagram illustrating a hardware configuration of an advertisement server according to a second embodiment of the present invention. In addition to the configuration of the first embodiment, this advertisement server 1 further includes a base rate storage 155. FIG. 15 is a diagram illustrating a record layout of a base rate storage according to a second embodiment of the present invention. The base rate storage 155 has “level” fields and “base rate” fields. Base rates are stored in the base rate storage 155 in association with levels.

FIG. 16 is a diagram illustrating a record layout of a history storage according to a second embodiment of the present invention. The history storage 154 further includes “number of validities” fields and “validity rate” fields in addition to the layout in the first embodiment. The “number of validities” fields store numbers of times when the clicked coordinate is determined to be valid in association with the superimposition dates & times for each IP address from which clicked coordinate is transmitted. The “validity rate” fields store values obtained by dividing numbers of validities by the total numbers of transmitted clicked coordinates as validity rates for the IP address. For example, the numbers of validities for clicked coordinates transmitted from the personal computer 2 with IP address “255.XX.XX1” are stored as 50, 50, and 51, with one determination result indicating “invalid”. The validity rates, each of which is a value obtained by dividing the number of validities by the total number of transmitted clicked coordinates, for those numbers of validities are stored as 84%, 82%, and 83%, respectively.

Each time it is determined that clicked coordinate exists within a superimposition area, the CPU 11 increments the number of validities, determines the validity rate by dividing the number of validities by the total number of clicked coordinates transmitted from the personal computer 2, and stores the determined validity rate in the history storage 154. The CPU 11 reads a base rate corresponding to a level from the base rate storage 155. When the validity rate is smaller than the read base rate, the CPU 11 determines that the clicking is a fraudulent operation. That is, the CPU 11 determines that the clicking is fraudulent sequential clicking using software. On the other hand, when the validity rate is greater than or equal to the read base rate, the CPU 11 determines that the clicking is manually performed.

The level, i.e., a base rate, is appropriately selected from the levels stored in the base rate storage 155 by an operator via the input unit 13. The CPU 11 reads a base rate corresponding to the level selected via the input unit 13.

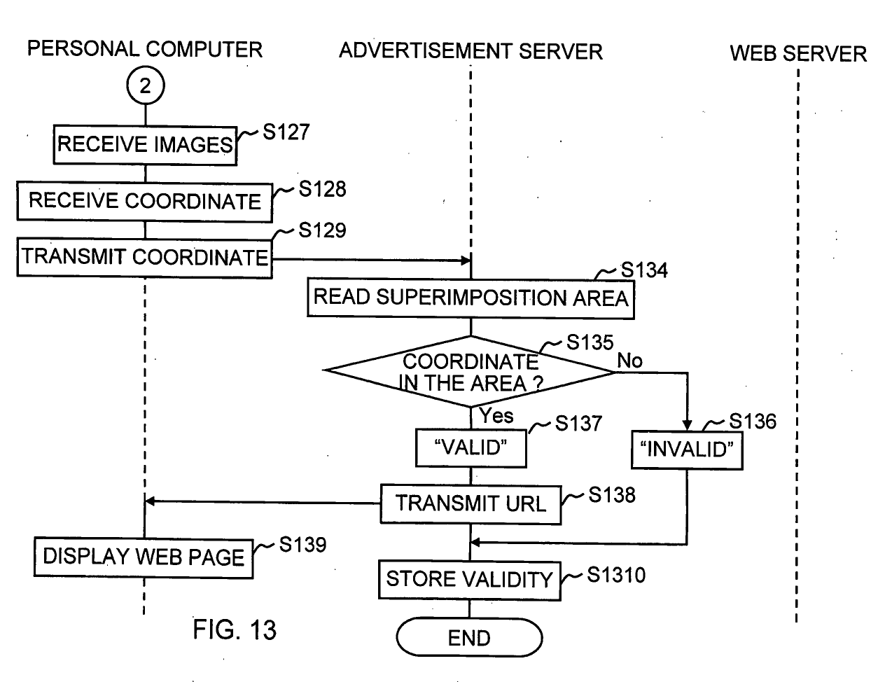

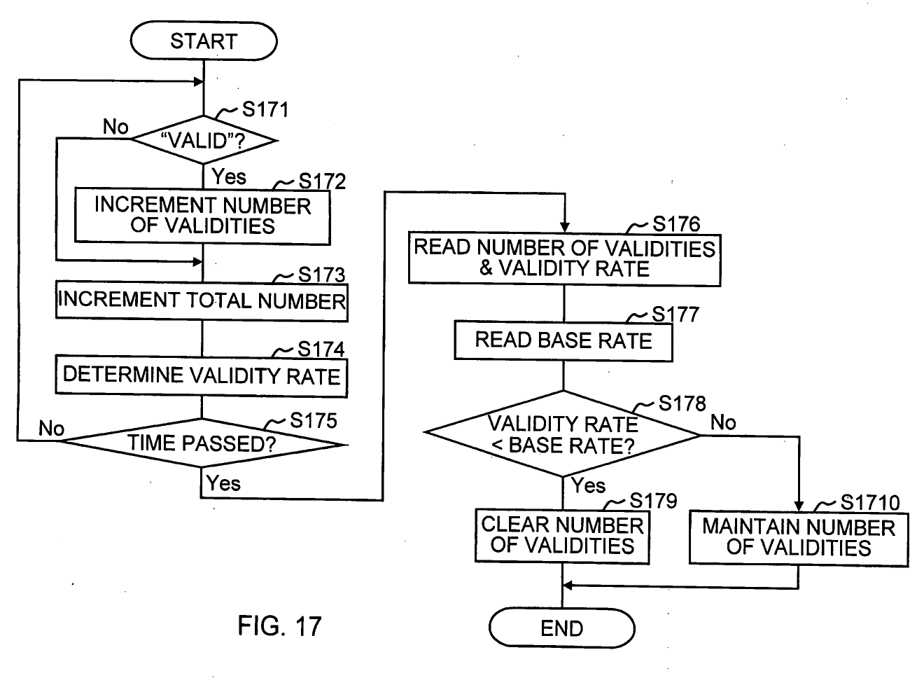

FIG. 17 is a diagram illustrating a flowchart of a procedure for identifying a fraudulent operation using software according to a second embodiment of the present invention. In step S171, the CPU 11 determines whether it is determined that the clicked coordinate is valid in step S137 (see FIG. 13). Upon determining that the clicked coordinate is valid in step S137 (Yes in step S171), in step S172, the CPU 11 increments the number of validities in the history storage 154. On the other hand, upon determining that the clicked coordinate is invalid in step S136 (No in step S171), the step S172 is skipped. Subsequent to step S172 or upon determining that the result is “No” in step S171, the CPU 11 increments the total number of transmitted clicked coordinates in step S173.

In step S174, the CPU 11 determines a validity rate by dividing the number of validities by the total number of transmitted clicked coordinates, and stores the determined validity rate in the history storage 154. In step S175, the CPU 11 determines whether a predetermined amount of time has passed by referring to an output from the clock 19. The predetermined amount of time may be, for example, one hour from first superimposition date & time. When the CPU 11 determines that the predetermined amount of time has not passed (No in step S175), the process proceeds to step S171 and the CPU 11 repeatedly executes the above-described processing for storing data. On the other hand, upon determining that the predetermined amount of time has passed (Yes in step S175), the CPU 11 reads a last number of validities and a last validity rate in the predetermined amount of time in step S176. For example, when the predetermined amount of time has passed after the superimposition date & time “at 17:18:30 on Mar. 1 in 2007” is stored in the history storage 154, the last number of validities is 51 and the last validity rate is 83%.

In step S177, the CPU 11 reads, from the base rate storage 155, a base rate corresponding to the level input via the input unit 13. In step S178, the CPU 11 determines whether the last validity rate is smaller than the read base rate. Upon determining that the last validity rate is smaller than the read base rate (Yes in step S178), the CPU 11 rewrites the numbers of validities in the predetermined amount of time stored in the history storage 154, to zero in step S179. For example, in the example of FIG. 16, the CPU 11 rewrites the numbers of validities for the superimposition date & time within one hour before 17:18:30 on Mar. 1 in 2007 to zero. On the other hand, upon determining that the last validity rate is greater than or equal to the read base rate (No in step S178), the CPU 11 determines that the click operations by software are not performed and maintains the stored numbers of validities in the predetermined amount of time in the history storage 154 in step S1710.

Thereafter, the CPU 11 determines an amount to be billed to the advertiser by multiplying the number of validities by a unit price stored in the storage 15. The CPU 11 reads the advertiser's electronic mail address stored in the storage 15. The advertisement server 1 transmits the number of validities and the determined billing amount to the electronic mail address via the communicator 16. Although the determination was made on the basis of whether the validity rate in the predetermined amount of time is smaller than pre-stored rate in the second embodiment, the arrangement may also be such that, when the total number of clicked coordinates reaches a predetermined number (e.g., 100), the CPU 11 determines a validity rate and makes a determination on the basis of whether the validity rate for the predetermined number is smaller than a pre-stored rate.

Configuration, other than the above-described configuration of the second embodiment, and operation thereof are analogous to those of the first embodiment, and thus, like units are denoted by like numerals and details thereof are omitted.

### Third Embodiment

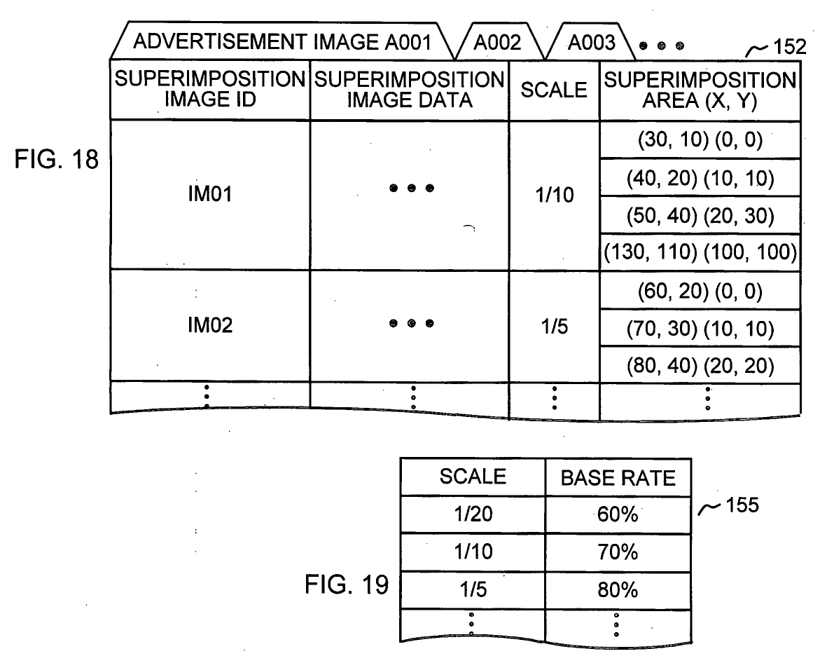

A third embodiment of the present invention relates to a scheme for determining a size of a superimposition image 10 and for generating a superimposition area on the basis of a size of an advertisement image 20. The CPU 11 reads data of an advertisement image 20 from the advertisement image DB 151 shown in FIG. 4 and performs processing for determining a size of a superimposition image 10 and for generating a superimposition area in accordance with the size of the advertisement image 20 and a predetermined scale. FIG. 18 is a diagram illustrating a record layout of a superimposition image DB according to a third embodiment of the present invention for storing data of generated superimposition images and data of generated superimposition areas. The CPU 11 first reads data of an advertisement image area from the advertisement image DB 151. For example, the CPU 11 reads data of an advertisement image area (300, 100) (0, 0) with advertisement image ID “A001”. The CPU 11 then determines a superimposition area by multiplying data of the advertisement image area by a scale stored in the storage 15. The CPU 11 enlarges or reduces template data of the superimposition image 10 so that the superimposition image 10 fits in the superimposition area.

The CPU 11 stores, in the superimposition image DB 152, data of the superimposition image 10 generated through the above-described processing and data of the superimposition area determined through the above-described processing. For each advertisement image 20, the superimposition image DB 152 has “superimposition image ID” fields, “superimposition image data” fields, “scale” fields, and “superimposition area” fields. The “scale” fields store proportions of sizes of superimposition images 10 (that is, sizes of superimposition areas) to the sizes of advertisement images 20. The proportion may be a numeric value by which the x-coordinate value and the y-coordinate value of the advertisement image 20 are to be multiplied. For example, when the stored scale is 1/10 and the advertisement image area has an area (300, 100) (0, 0), the superimposition area becomes an area (30, 10) (0, 0), which are obtained by multiplying the x-coordinate values and the y-coordinate values by 1/10. When the template data of the superimposition image 10 has an area (300, 100) (0, 0), the superimposition image 10 is also reduced to have an area (30, 10) (0, 0) so that the superimposition image 10 is fits in the superimposition area.

The CPU 11 stores, in a “superimposition image data” field, data of the superimposition image 10 multiplied by the scale, and stores, in a “superimposition area” field, data of the superimposition area multiplied by the scale. The CPU 11 generates multiple superimposition areas by adding predetermined values to the x-coordinate value and the y-coordinate value of the scaled superimposition area so that one superimposition image 10 has multiple superimposition areas, and stores data of the generated superimposition areas in the superimposition image DB 152. In the example of FIG. 18, data of a superimposition area (30, 10) (0, 0), data of a superimposition area (40, 20) (10, 10), and so on with scale “ 1/10” are stored in association with the superimposition image ID “IM01”. The value of scale is appropriately input by an operator via the input unit 13. The CPU 11 stores the input scale in the “scale” fields of the superimposition image DB 152.

In the example of FIG. 18, scale “⅕” is also stored. In this case, a superimposition image 10 having a larger area is generated compared to the case of scale “ 1/10”. When the scale is ⅕ and the advertisement image area is an area (300, 100) (0, 0), the superimposition area becomes an area (60, 20) (0, 0) which is obtained by multiplying the x-coordinate value and the y-coordinate value by ⅕. When the template data of the superimposition image 10 has an area (300, 100) (0, 0), the superimposition area is also reduced to an area (60, 20) (0, 0). Also in the case of scale “⅕”, multiple superimposition areas such as an area (70, 30) (10, 10) are similarly generated and data thereof are stored.

FIG. 19 is a diagram illustrating a record layout of a base rate storage according to a third embodiment of the present invention. The base rate storage 155 has “scale” fields and “base rate” fields. Base rates are stored in association with scales among which the scale to be stored in the superimposition image DB 152 is selected. For example, base rate “60%” is stored for scale “ 1/20”. The base rate is increased to 80% for scale “⅕” since the superimposition area for the superimposition image 10 is larger and a possibility that the user clicks on an area other than the superimposition area in the advertisement image 20 is reduced. Thus, in the third embodiment, as the scale is increased, the stored base rate is also increased. The CPU 11 reads the contents stored in the base rate storage 155 and executes the processing illustrated in FIG. 17.

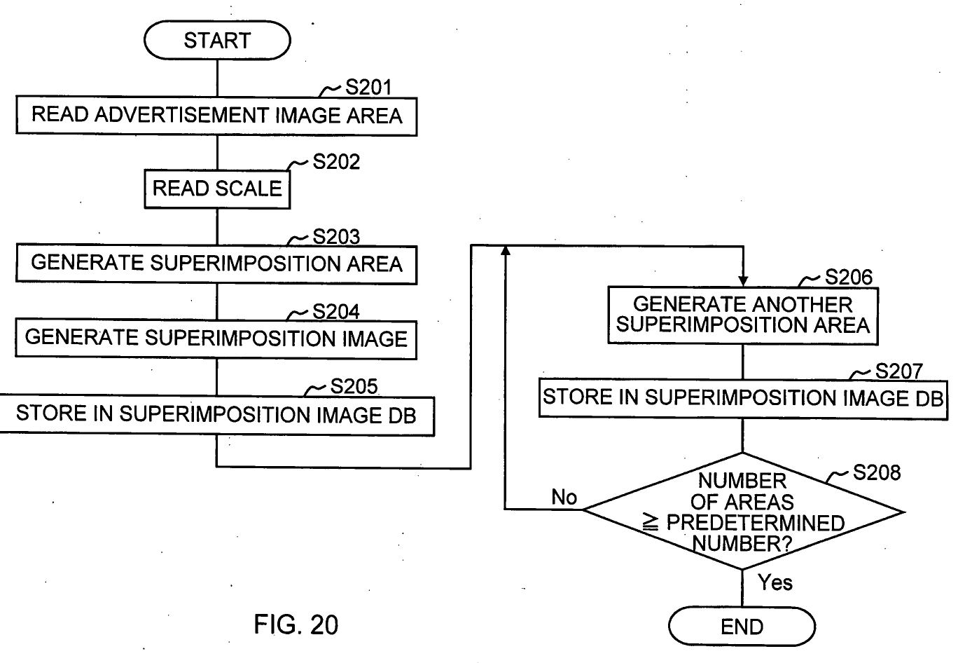

FIG. 20 is a diagram illustrating a flowchart of a procedure for generating a superimposition image and a superimposition area according to a third embodiment of the present invention. In step S201, the CPU 11 reads data of an advertisement image area from the advertisement image DB 151. In step S202, the CPU 11 reads a scale stored in the superimposition image DB 152. In step S203, the CPU 11 generates a superimposition area by multiplying the x-coordinate value and the y-coordinate value of the read advertisement image area by the read scale. In step S204, the CPU 11 reads template data of a superimposition image 10 from the storage 15 and generates a superimposition image 10 that fits in the superimposition area by multiplying the x-coordinate value and the y-coordinate value by the scale.

In step S205, the CPU 11 stores data of the generated superimposition image 10 and data of the generated superimposition area in the superimposition image DB 152 in association with the advertisement image ID, the superimposition image ID, and the scale, as shown in FIG. 18. In addition, in step S206, the CPU 11 generates another superimposition area by adding predetermined value (e.g., 10) to the x-coordinate value and the y-coordinate value of the generated superimposition area. In step S207, the CPU 11 stores data of the other generated superimposition area in the superimposition image DB 152 in association with the advertisement image ID, the superimposition image ID, and the scale. In step S208, the CPU 11 determines whether number of superimposition areas generated in steps S203 and S206 is greater than or equal to a predetermined number (e.g., 3).

When the number of superimposition areas is less than the predetermined number (No in step S208), the process proceeds to step S206. Then, in step S206, the CPU 11 successively generates a different superimposition area by adding a different predetermined value. Upon determining that the number of superimposition areas is greater than or equal to the predetermined number (Yes in step S208), the CPU 11 ends the series of processing. The above-described processing is performed on all scales stored in the superimposition image DB 152. When the processing for generating superimposition images 10 and superimposition areas is finished with respect to one advertisement image area, the processing is similarly executed on another advertisement image area, i.e., an advertisement image area (200, 100) (0, 0) with advertisement image ID “A002”.

Configuration, other than the above-described configuration of the third embodiment, and operation thereof are analogous to those of the first and second embodiments, and thus, like units are denoted by like numerals and details thereof are omitted.

### Fourth Embodiment

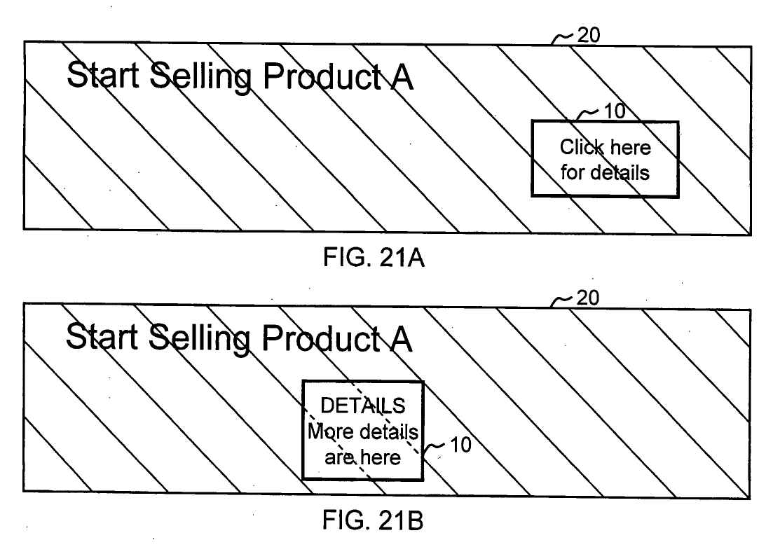

A fourth embodiment of the present invention relates to a scheme for changing color of a superimposition image 10. FIGS. 21A and 21B are schematic views each showing an advertisement image superimposed with a superimposition image according to a fourth embodiment of the present invention. More specifically, FIG. 21A is a schematic view showing an advertisement image 20 colored with a predetermined color superimposed with a superimposition image 10 colored with the same color. The CPU 11 extracts color data of an advertisement image 20. The CPU 11 then reads, from the superimposition image DB 152, data of a superimposition image 10 to be superimposed. In this case, it is assumed that the color data has not yet been added to the superimposition image 10. The CPU 11 generates a superimposition image 10 having color data that is the same as or closely similar to that of the advertisement image 20. Specifically, with respect to an area other than an image of characters in the superimposition image 10, the CPU 11 generates a superimposition image 10 having the same color data as R, G, and B values of the advertisement image 20. In the description below, an area other than an image of characters in an advertisement image 20 or a superimposition image 10 will be referred to as a “background image”. A predetermined value (e.g., 10) may be added to or subtracted from the R, G, and B values of the advertisement image 20 to determine R, G, and B values and color data having the determined R, G, and B values is added to generate a superimposition image 10. This makes it difficult for software to perform color recognition processing on the superimposition image 10.

FIG. 21B is a schematic view showing an advertisement image 20 colored with a predetermined color superimposed with a superimposition image 10 colored with the same color and having a predetermined transmittance. The CPU 11 extracts color data of an advertisement image 20. The CPU 11 then reads, from the superimposition image DB 152, data of a superimposition image 10 to be superimposed. In this case, it is assumed that the color data has not yet been added to the superimposition image 10. The CPU 11 adds the same or similar color data, in the same manner as the above-described processing, and generates a superimposition image 10 by performing image processing so that it has the predetermined transmittance (e.g. 80%, 10%, or the like) with respect to the background image. Other than making the advertisement image 20 and the superimposition image 10 have the same color, the transmittance of the superimposition image 10 may be set to 100% so that areas other than an image of characters in the superimposition image 10 becomes transparent.

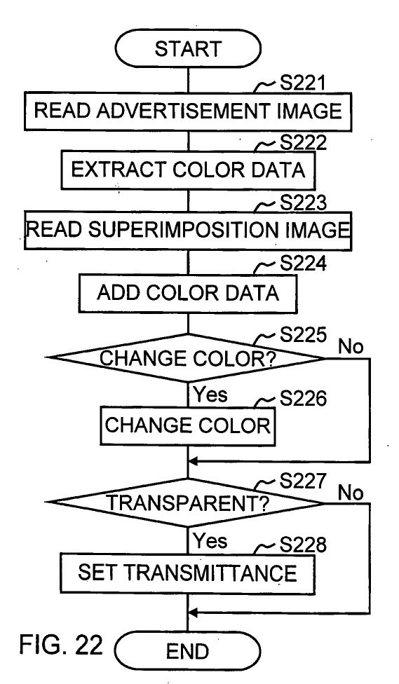

FIG. 22 is a diagram illustrating a flowchart of a procedure for coloring processing according to a fourth embodiment of the present invention. In step S221, the CPU 11 of the advertisement server 1 reads, from the advertisement image DB 151, data of an advertisement image 20 to be processed. In step S222, the CPU 11 extracts color data of the read advertisement image 20. The color data extracted in this case is color data regarding the background image in areas other than an image of characters. In step S223, the CPU 11 reads, from the superimposition image DB 152, data of a superimposition image 10 to be superimposed. In step S224, with respect to the background image of the superimposition image 10, the CPU 11 adds the color data (extracted in step S222) of the advertisement image 20 to the superimposition image 10. In step S225, the CPU 11 determines whether to perform processing for changing the color to a color that is different from the color of the advertisement image 20. The determination as to whether the color changing processing is to be executed can be set by the operator via the input unit 13 and the setting information is stored in the storage 15.

Upon determining that the color changing processing is to be executed (Yes in step S225), in step S226, the CPU 11 adds or subtracts a predetermined value to or from the read color data so as to change the color of the superimposition image 10 with respect to the background image of the superimposition image 10 and adds the resulting color data the superimposition image 10. On the other hand, upon determining that the color changing processing is not to be performed (No in step S225), the color changing processing is not require and the CPU 11 thus step S226 is skipped. After this processing and after the processing in step S226, the CPU 11 determines whether to perform processing for making the superimposition image 10 transparent in step S227. The determination as to whether the transparency processing is to be performed and the information of the transmittance can be set by the operator via the input unit 13 and the setting information is stored in the storage 15.

Upon determining that the transparency processing is to be performed (Yes in step S227), in step S228, the CPU 11 reads the transmittance stored in the storage 15 and sets the read transmittance for the color data added in step S224 or S226 with respect to the background image of the superimposition image 10. On the other hand, upon determining that the transparency processing is not to be executed (No in step S227), step S228 is skipped and the CPU 11 ends the processing. The superimposition image 10 generated as described above is given a superimposition image ID and data thereof is then stored in the superimposition image DB 152. The superimposition image 10 subjected to the coloring processing, as described above, is superimposed on the advertisement image 20 and data of the resulting image is transmitted to the personal computer 2.

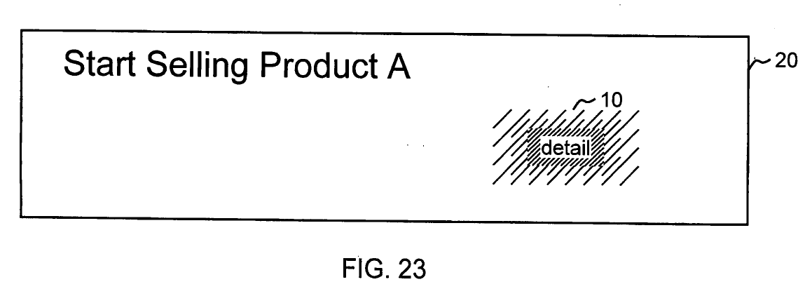

FIG. 23 is a schematic view showing an advertisement image superimposed with a superimposition image performed gradation processing according to a fourth embodiment of the present invention. As shown in FIG. 23, the background image of a superimposition image 10 is subjected to gradation processing by which the color gradually changes from a center of the background image toward a periphery thereof. Performing the gradation processing makes it difficult to detect a periphery of the superimposition image 10. The CPU 11 reads color data with respect to the background images of the advertisement image 20 and the superimposition image 10. The CPU 11 then changes the color data of portions of the superimposition image 10 so that the R, G, and B values of the color data of the superimposition image 10 approach the R, G, and B values of the color data of the advertisement image 20 gradually from a center of the superimposition image 10 toward the periphery thereof. For example, when the background color of the advertisement image 20 is white and the background color of the superimposition image 10 is blue, the CPU 11 sets the R, G, and B values so that the blue at the center of the superimposition image 10 changes to white gradually toward the periphery thereof.

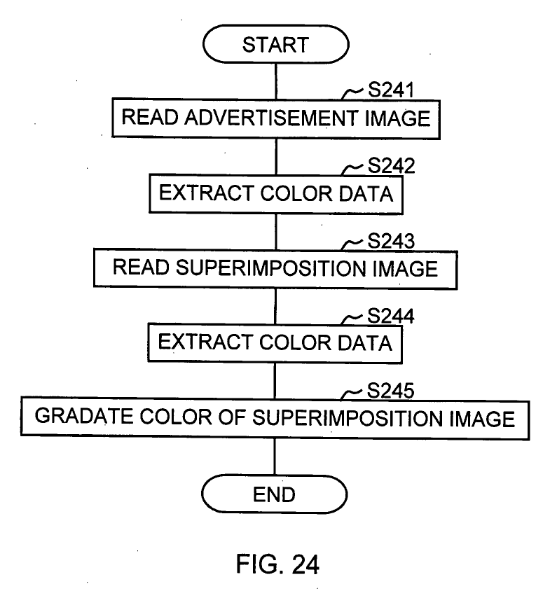

FIG. 24 is a diagram illustrating a flowchart of a procedure for the gradation processing according to a fourth embodiment of the present invention. In step S241, the CPU 11 reads data of an advertisement image 20 from the advertisement image DB 151. In step S242, the CPU 11 extracts color data of the read advertisement image 20. In step S243, the CPU 11 reads data of a superimposition image 10 from the superimposition image DB 152. In step S244, the CPU 11 extracts color data of the read superimposition image 10. In step S245, the CPU 11 changes the color data of the superimposition image 10 from the center of the superimposition image 10 toward the periphery thereof so that the color data on the periphery becomes equal to the color data of the advertisement image 20. The superimposition image 10 subjected to the gradation processing, as described above, is superimposed on the advertisement image 20 and data of the resulting image is transmitted to the personal computer 2.

Configuration, other than the above-described configuration of the fourth embodiment, and operation thereof are analogous to those of the first to third embodiments, and thus, like units are denoted by like numerals and details thereof are omitted.

### Fifth Embodiment

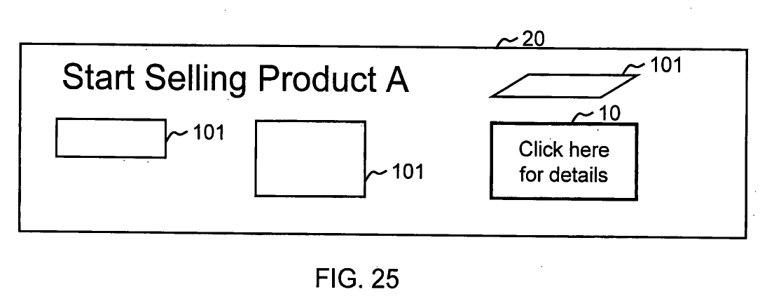

A fifth embodiment of the present invention relates to a scheme for superimposing, on an advertisement image 20, images associated with a superimposition image 10. FIG. 25 is a schematic view showing an advertisement image superimposed with images associated with a superimposition image according to a fifth embodiment of the present invention. Associated images 101 generated on the basis of a contour image of a superimposition image 10 are superimposed on the advertisement image 20. This arrangement makes it difficult for edge detection software to easily extract the superimposition image 10. The CPU 11 reads data of a superimposition image 10 from the superimposition image DB 152 and extracts a contour image of the superimposition image 10. Specifically, the CPU 11 performs edge detection on the superimposition image 10 except for images of characters therein and extracts the detected contour as a contour image. This contour image has, for example, a black contour and a transparent rectangular background. In this case, number of pixels (the number of coordinates) of the longitudinal and lateral sides of the rectangle can be recognized by the edge detection.

The CPU 11 generates an associated image 101 that has the same contour as the extracted contour image or an associated image 101 that is obtained by changing the contour image. The associated image 101 may be exactly the same as the contour image, or may be a rectangular image having dimensions obtained by multiplying the dimensions of the longitudinal or lateral side of the contour image by a predetermined coefficient or obtained by adding or subtracting a predetermined value to or from the dimensions of the longitudinal or lateral side of the contour image. The CPU 11 may also generate an associated image 101 having a parallelogram shape whose angles defined by the longitudinal and lateral sides are changed by a predetermined value from 90°. Although the associated image 101 has been generated on the basis of the rectangular contour image in the fifth embodiment, the present invention is not limited thereto.

For example, an associated image 101 may be generated on the basis of a contour image resulting from a circular or triangular superimposition image 10. In this case, the CPU 11 may generate a circle or oval associated image 101 having a different size by changing the radius of the circle or changing a longitudinal or lateral axis thereof. In addition, the CPU 11 may generate a triangular associated image 101 having a different shape by changing the dimensions of the sides of a triangular contour image or changing the interior angles of a triangular contour image. The associated image 101 generated as described above is superimposed on an area other than the superimposition area in the advertisement image 20.

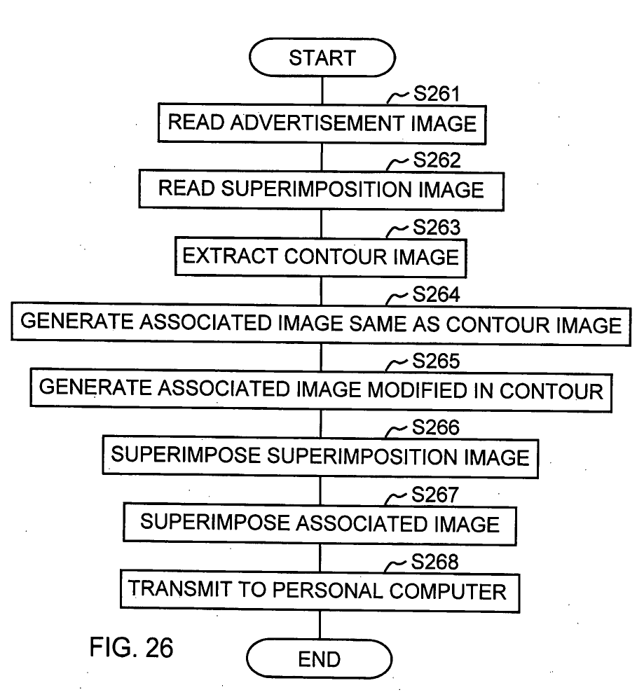

FIG. 26 is a diagram illustrating a flowchart of a procedure for generating an associated image according to a fifth embodiment of the present invention. In step S261, the CPU 11 reads data of an advertisement image 20 from the advertisement image DB 151. In step S262, the CPU 11 reads data of a superimposition image 10 from the superimposition image DB 152. In step S263, the CPU 11 extracts a contour image of the read superimposition image 10. In step S264, the CPU 11 generates an associated image 101 that is the same as the extracted contour image. In step S265, the CPU 11 generates an associated image by changing, for example, the longitudinal or lateral side of the contour image. In this case, the arrangement may also be such that only one of the processing in step S264 and the processing in step S265 is executed.

As described in the first embodiment, in step S266, the CPU 11 superimposes the superimposition image 10 on a superimposition area in the advertisement image 20. In step S267, the CPU 11 superimposes the associated images 101 generated in steps S264 and S265 on areas other than the superimposition area in the advertisement image 20. In step S268, the CPU 11 transmits, to the personal computer 2, data of the resulting advertisement image 20 superimposed with the associated images 101 and the superimposition image 10.

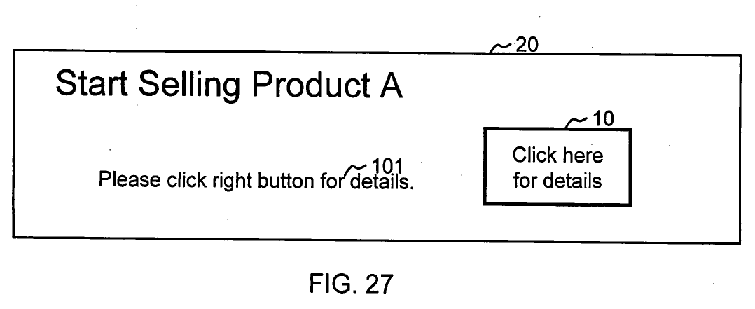

FIG. 27 is a schematic view showing an advertisement image superimposed with an associated image of characters according to a fifth embodiment of the present invention. An associated image 101 having characters associated with characters in the superimposition image 10 is superimposed on an area other than the superimposition area in the advertisement image 20. The characters in the associated image 101 include at least one word among the words displayed on the superimposition image 10. For example, characters “Click here for details” are stated on the superimposition image 10 in this example. On the other hand, the associated image 101 has words “Details” and “Click” as in the characters “Please click right button for details”. For the characters displayed on the associated image 101, the user may input appropriate characters via the input unit 13 by referring to the statement on the superimposition image 10.

The CPU 11 converts the input characters into image data having a background image with a transmittance of 100% except for the portions of the characters and stores the image data in the storage 15 as an associated image 101. The size of the associated image 101 may be substantially the same as the superimposition area of the superimposition image 10. The CPU 11 superimposes the converted associated image 101 on an area other than the superimposition area in the advertisement image 20. Consequently, a statement including the words on the superimposition image 10 is displayed on the advertisement image 20. Thus, even with software having an OCR (optical character recognition) function, it is difficult to recognize the superimposition image 10.

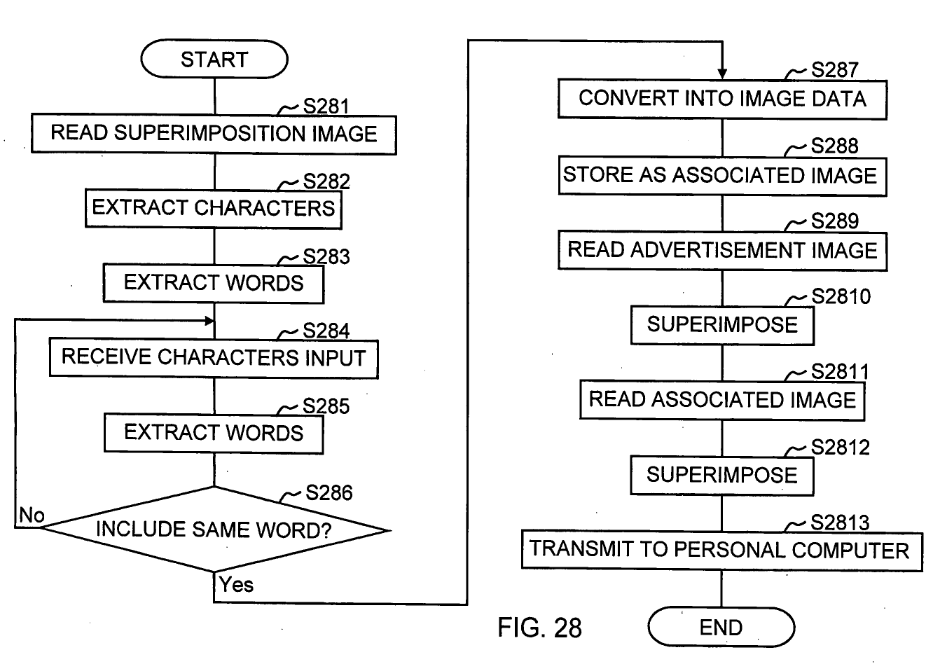

FIG. 28 is a diagram illustrating a flowchart of a procedure for generating an associated image according to a fifth embodiment of the present invention. In step S281, the CPU 11 reads, from the superimposition image DB 152, data of a superimposition image 10 to be superimposed. In step S282, the CPU 11 extracts characters that exist in the superimposition image 10. The character extraction may be performed using the OCR software. In step S283, the CPU 11 extracts words included in the characters extracted from the superimposition image 10. In the extraction processing, words, such as noun, verb, and/or adjective pre-stored in the storage 15 may be extracted.

Via the input unit 13, the operator inputs desired characters he or she desires to superimpose on the advertisement image 20. In step S284, the CPU 11 receives the characters input via the input unit 13. In step S285, the CPU 11 extracts words that exist in the received characters. In this extraction processing, similarly, words, such as noun, verb, and/or adjective pre-stored in the storage 15 may be extracted. In step S286, the CPU 11 determines whether the words in the characters received in step S284 exists in the words extracted from the superimposition image 10 in step S283.

Upon determining that the words in the received characters do not exist in the words extracted from the superimposition image 10 in step S283 (i.e., No in step S286), the CPU 11 causes the display unit 14 to display a message for prompting input of characters again, and the process proceeds to step S284. The message is pre-stored in the storage 15 and is, for example, “Please input the same word as the word in the superimposition image”. Upon determining that the words in the received characters exist in the words extracted from the superimposition image 10 in step S283 (i.e., Yes in step S286), the CPU 11 converts the characters received in step S284 into image data in step S287.

In step S288, the CPU 11 stores the converted image data in the storage 15 as an associated image 101. In step S289, the CPU 11 reads, from the advertisement image DB 151, data of an advertisement image 20 to be superimposed. In step S2810, as described in the first embodiment, the CPU 11 superimposes the superimposition image 10 on a superimposition area in the advertisement image 20. In step S2811, the CPU 11 reads data of the associated image 101 stored in step S288. In step S2812, the CPU 11 superimposes the read associated image 101 on an area other than the superimposition area in the advertisement image 20. In step S2813, the CPU 11 transmits, to the personal computer 2, data of the resulting advertisement image superimposed with the associated image and the superimposition image 10.

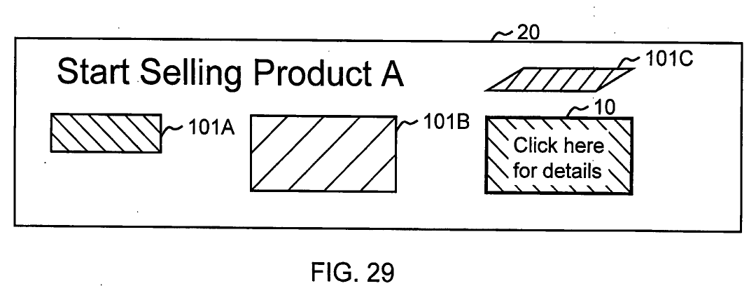

FIG. 29 is a schematic view showing an advertisement image superimposed with associated images according to a fifth embodiment of the present invention. The associated images 101 shown in FIG. 29 include an associated image 101A having a different shape from a superimposition image 10, an associated image 101B having different color from the superimposition image 10, and an associated image 101C having a different shape and color from the superimposition image 10. The CPU 11 applies color that is the same as or is different from that of the superimposition image 10 to the associated images 101A, 101B, and 101C shown in FIG. 29 (hereinafter, these associated images are also referred to as an “associated image 101”). Thus, even with image recognition software, it is difficult to easily recognize the superimposition image 10.

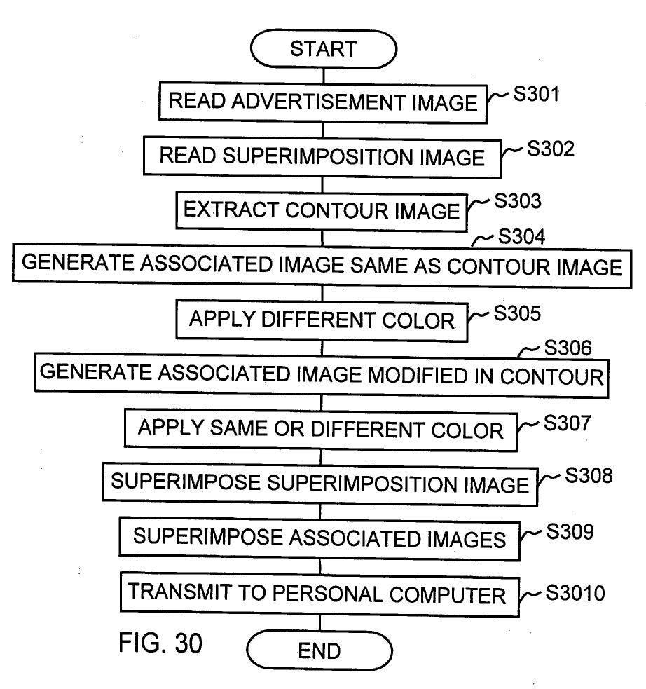

FIG. 30 is a diagram illustrating a flowchart of a procedure for generating an associated image according to a fifth embodiment of the present invention. In step S301, the CPU 11 reads data of an advertisement image 20 from the advertisement image DB 151. In step S302, the CPU 11 reads data of a superimposition image 10 from the superimposition image DB 152. In step S303, the CPU 11 extracts a contour image of the read superimposition image 10. In step S304, the CPU 11 generates an associated image 101 that is the same as the extracted contour image. In step S305, the CPU 11 applies color that is different from that of the superimposition image 10 to the generated associated image 101.

In step S306, the CPU 11 generates an associated image 101 by changing, for example, the longitudinal or lateral side of the contour image. In step S307, the CPU 11 applies color that is the same as or is different from that of the superimposition image 10 to the associated image 101 generated in step S306. In step S308, as described in the first embodiment, the CPU 11 superimposes the superimposition image 10 on a superimposition area in the advertisement image 20. In step S309, the CPU 11 superimposes, on areas other than the superimposition area in the advertisement image 20, the associated images 101 to which the color was applied in steps S305 and S307. In step S3010, the CPU 11 transmits, to the personal computer 2, data of the resulting advertisement image 20 superimposed with the associated images 101 and the superimposition image 10.

Configuration, other than the above-described configuration of the fifth embodiment, and operation thereof are analogous to those of the first to fourth embodiments, and thus, like units are denoted by like numerals and details thereof are omitted.

### Sixth Embodiment

A sixth embodiment of the present invention relates to a scheme for generating a superimposition image 10 by changing coefficients. In the advertisement server 1 in the sixth embodiment, coefficients for generating a geometric graphics are stored in the storage 15. The geometric graphics has, for example, a rectangular, circular, triangular, pentagonal, or oval shape, as mentioned in the first embodiment. A description in the sixth embodiment is given assuming that the geometric graphics has an oval shape.

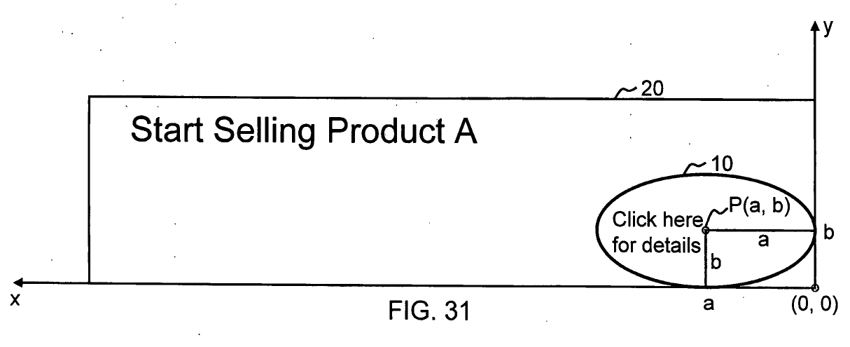

FIG. 31 is a schematic view showing an advertisement image superimposed with a superimposition image of a geometric graphics according to a sixth embodiment of the present invention. In an x and y coordinate system, an oval is defined by a lateral-axis radius a in the x-axis direction, a longitudinal-axis radius b in the y-axis direction, and a center P (a, b). A maximum value (e.g., 80) and a minimum value (e.g., 20) of the lateral-axis radius a and the longitudinal-axis radius b are stored in the storage 15 corresponding to the area of the advertisement image 20. Coefficients a and b are stored in the storage 15 as coefficients for the oval superimposition image 10.

For generating a superimposition image 10, the CPU 11 assigns two arbitrarily selected values to the coefficients a and b. The CPU 11 then reads characters for prompting clicking that are pre-stored in the storage 15, converts the characters into image data, and generates a superimposition image 10 by superimposing the image of characters in the oval to which the coefficients were assigned. The storage 15 stores a table (not shown) in which font sizes are stored in association with the coefficients. Data thereof are stored so that the font size increases as the coefficient becomes large.

The CPU 11 determines the font size of the characters by referring to the table. For example, when a smaller value among input coefficients a and b is 30, the font size needs to be small and is thus set to “11”, and when a smaller value among input coefficients a and b is 70, the font size needs to be large and is thus set to “20”. The CPU 11 stores, as data of a superimposition area, all coordinate values that exist within the oval defined by the center P(a, b), the lateral-axis radius a in the x-axis direction, and the longitudinal-axis radius b in the y-axis direction. The CPU 11 assigns a new superimposition image ID and stores data of a superimposition image 10 generated and data of the superimposition area represented by a mask pattern in the superimposition image DB 152 in association with the superimposition image ID.

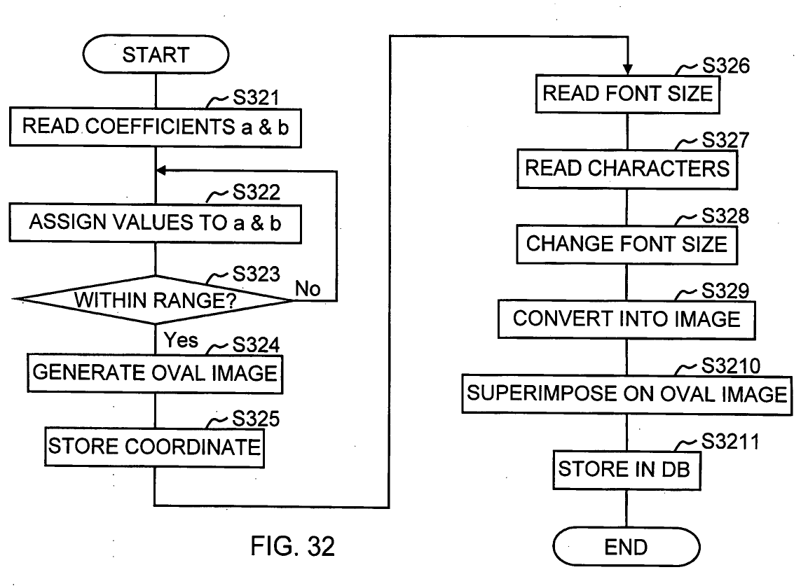

FIG. 32 is a diagram illustrating a flowchart of a procedure for generating a superimposition image of a geometric graphics according to a sixth embodiment of the present invention. In step S321, the CPU 11 reads, from the storage 15, coefficients a and b that define an oval. In step S322, the CPU 11 assigns arbitrary numeric values to the read coefficients a and b. In step S323, the CPU 11 determines whether the numeric values assigned to the coefficients a and b are within the range from the minimum value to the maximum value stored in the storage 15. Upon determining that the numeric values are not within the range from the minimum value to the maximum value (No in step S323), the size of the superimposition image 10 is likely to be too small or large relative to the advertisement image 20. Thus, the process proceeds to step S322, in which the CPU 11 assigns arbitrary numeric values to the coefficients a and b again.

Upon determining that the coefficients a and b are within the range from the minimum value to the maximum value (Yes in step S323), in step S324, the CPU 11 generates an oval image having a center of (a, b), a radius of a in the x-axis direction, and a radius of b in the y-axis direction in accordance with the numeric values assigned to a and b. In step S325, the CPU 11 stores coordinates existing within the generated oval image in the superimposition image DB 152 as data of a superimposition area. In step S326, the CPU 11 reads, from the table stored in the storage 15, a font size corresponding to the numeric values assigned to the coefficients. In step S327, the CPU 11 reads characters stored in the storage 15. In step S328, the CPU 11 changes the font size of the read characters.

In step S329, the CPU 11 converts the characters into an image. In step S3210, the CPU 11 generates a superimposition image 10 by superimposing the image of characters on the oval image. In step S3211, the CPU 11 stores data of the generated superimposition image 10 in the superimposition image DB 152 in association with data of the superimposition area stored in step S325.

Configuration, other than the above-described configuration of the sixth embodiment, and operation thereof are analogous to those of the first to fifth embodiments, and thus, like units are denoted by like numerals and details thereof are omitted.

### Seventh Embodiment

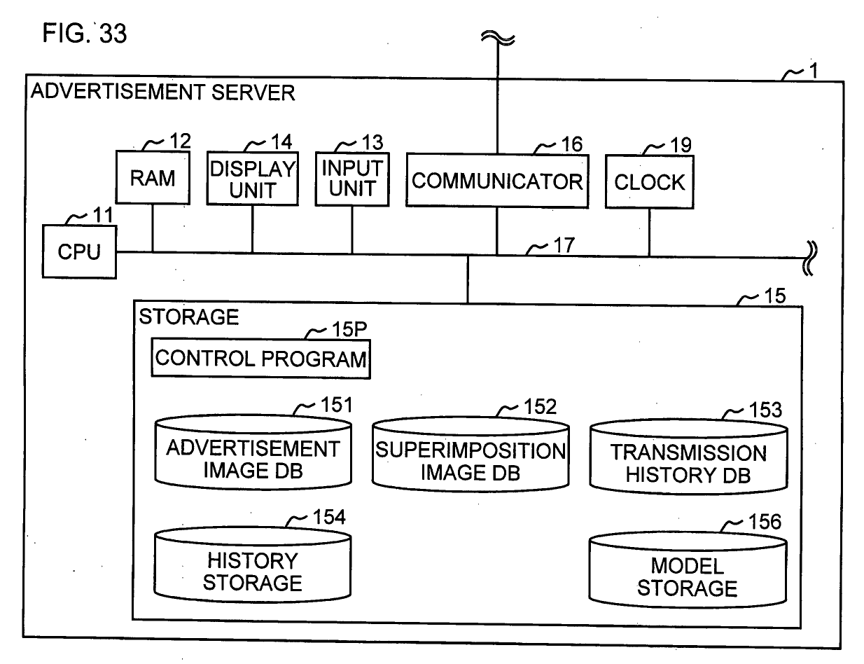

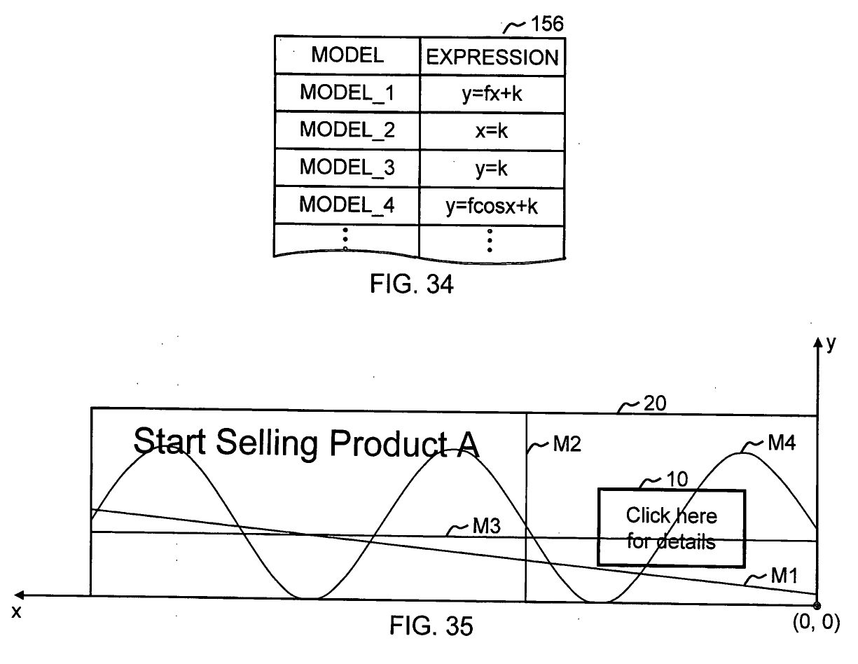

A seventh embodiment of the present invention relates to a scheme for identifying fraud by using a trajectory of clicked coordinates. FIG. 33 is a block diagram illustrating a hardware configuration of an advertisement server according to a seventh embodiment of the present invention. The storage 15 further includes a model storage 156. FIG. 34 is a diagram illustrating a record layout of a model storage according to a seventh embodiment of the present invention. The model storage 156 stores multiple models to detect a fraud in which software is used to execute a large number of fraudulent clicks on a browser window.

In the example of FIG. 34, mathematical expressions are stored for the models. For example, an expression y=fx+k is stored for model_1. FIG. 35 is a schematic view showing trajectories of clicked coordinates in accordance with models according to a seventh embodiment of the present invention. In FIG. 35, the expression y=fx+k for model_1 is expressed by a solid line M1. In the expression, f and k indicate coefficients, and multiple values for the coefficients are pre-stored in the model storage 156. When software installed on the personal computer 2 clicks on this advertisement image 20 in accordance with y=fx+k while appropriately changing the clicked coordinates, the CPU 11 determines a degree of correlation between the clicked coordinates transmitted to the advertisement server 1 and coordinates specified by model_1. When the degree of correlation is high, the CPU 11 determines that the clicking is a fraudulent operation.

An expression x=k is stored for model_2 in the model storage 156. As shown in FIG. 35, the expression x=k for model_2 is expressed by a solid line M2. Model_2 is effective against software that performs clicking entirely in the vertical direction. An expression y=k is stored for model_3 in the model storage 156. As shown in FIG. 35, the expression y=k for model_3 is expressed by a solid line M3. Model_3 is effective against software that performs clicking entirely in the horizontal direction. An expression y=f cos x+k is stored for model_4 in the model storage 156. As shown in FIG. 35, the expression y=f cos x+k for model_4 is expressed by a cosine-curve solid line M4. The above-described mathematical expressions for the models are merely examples and various other mathematical expressions may be stored in the model storage 156.

The CPU 11 reads a certain number of clicked coordinates from the history storage 154 shown in FIG. 9 and determines a degree of correlation between the series of read clicked coordinates and a series of a certain number of coordinates specified by the expression for the model stored in the model storage 156. A degree of correlation R is determined by the expression shown in FIG. 42, where the series of clicked coordinates is indicated by x={xᵢ} (i=1, 2, . . . n) and a series of clicked coordinates specified by the expression for the model is indicated by y={yᵢ} (i=1, 2, . . . n).

In expression shown in FIG. 42, x_{A} and y_{B} indicate arithmetic averages of the series x={xᵢ} and the series y={yᵢ}, respectively. In this case, the degree of correlation takes the value of −1 to +1. When the degree of correlation approaches +1, the correlation between two series is increased in the same vector direction. As the degree of correlation approaches 0, the correlation between two series is reduced. In addition, as the degree of correlation approaches −1, the correlation between two series is increased in opposite vector directions. The CPU 11 determines the degree of correlation and determines whether the degree of correlation is greater than or equal to a predetermined threshold (e.g., +0.8). When the degree of correlation is greater than or equal to the threshold, it is determined that the clicking is a fraudulent operation.

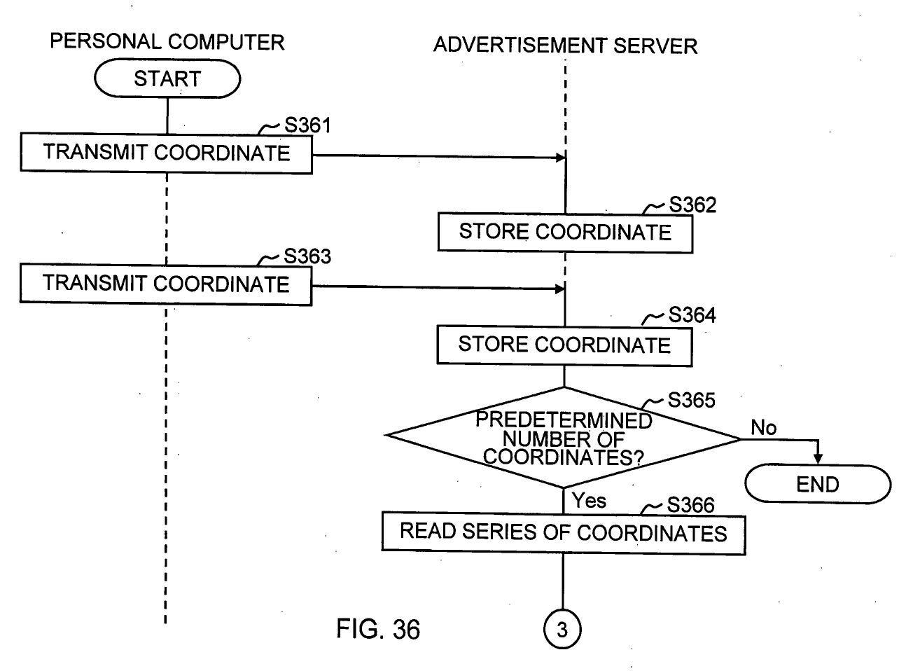

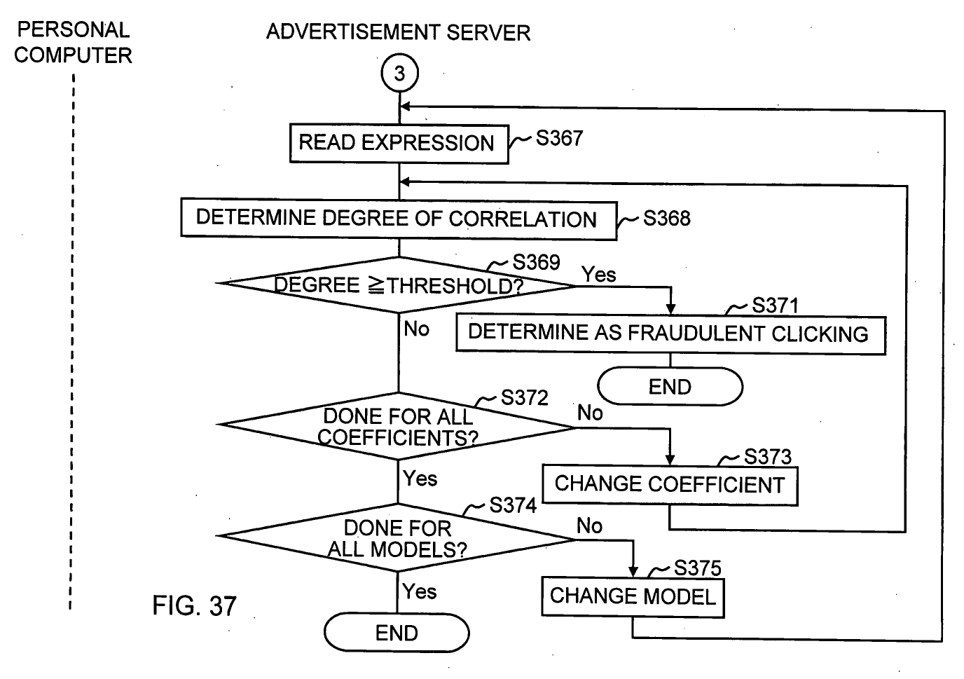

FIGS. 36 and 37 are diagrams illustrating a flowchart of a procedure for fraud identifying processing according to a seventh embodiment of the present invention. In step S361, the CPU 21 of the personal computer 2 receives a clicked coordinate input via the input unit 23 and transmits the received clicked coordinate to the advertisement server 1. In step S362, the CPU 11 of the advertisement server 1 stores the transmitted clicked coordinate in the history storage 154, as described in the first embodiment. When another clicked coordinate is input by the user or software via the input unit 23 of the personal computer 2, the CPU 21 receives the clicked coordinate and transmits the received clicked coordinate to the advertisement server 1 in step S363.

In step S364, the CPU 11 of the advertisement server 1 similarly stores the transmitted clicked coordinate in the history storage 154. Thereafter, in step S365, the CPU 11 determines whether a predetermined number of clicked coordinates is stored in the history storage 154. Upon determining that a predetermined number of clicked coordinates is not yet stored (No in step S365), the process ends. On the other hand, upon determining that a predetermined number of clicked coordinates is already stored (Yes in step S365), the CPU 11 reads the series of predetermined number of clicked coordinates stored in the history storage 154 in step S366. The series of clicked coordinates is arranged in order of transmission.

In step S367, the CPU 11 reads a mathematical expression for one model from the model storage 156. In step S368, the CPU 11 assigns coefficients, pre-stored in the model storage 156, to the read expression and determines a degree of correlation between a series of coordinates specified by the read expression and the series of the clicked coordinates read in step S366 in accordance with the expression (shown in FIG. 42) stored in the storage 15. In step S369, the CPU 11 reads a threshold stored in the storage 15 and determines whether the determined degree of correlation is greater than or equal to the threshold.

Upon determining that the degree of correlation is greater than or equal to the threshold (Yes in step S369), in step S371, the CPU 11 determines that the series of clicked coordinates transmitted from the personal computer 2 is fraudulent clicking using software. The CPU 11 then stores information indicating fraudulent clicking in association with the series of clicked coordinates read (in step S366) from the history storage 154. Upon determining that the degree of correlation is less than the threshold (No in step S369), in step S372, the CPU 11 determines whether the determination processing based on the degree of correlation has been executed on all coefficients stored in the model storage 156 for the mathematical expression.

Upon determining that the determination processing based on the degree of correlation has not been executed with some coefficients (No in step S372), in step S373, the CPU 11 reads new coefficients for the expression from the model storage 156 and changes the coefficients. Thereafter, the process proceeds to step S368, in which the CPU 11 executes the above-described processing with the coefficients. On the other hand, upon determining that the determination processing based on the degree of correlation has been executed with all coefficients (Yes in step S372), in step S374, the CPU 11 determines whether the above-described processing has been executed on all models stored in the model storage 156.

Upon determining that the above-described determination processing has not been executed on some models (No in step S374), in step S375, the CPU 11 changes the model to another model stored in the model storage 156. The process then proceeds to step S367, in which the CPU 11 executes similar processing with respect to an expression for another model. Upon determining that the above-described determination processing has been executed on all models (Yes in step S374), the CPU 11 ends the series of processing.

Configuration, other than the above-described configuration of the seventh embodiment, and operation thereof are analogous to those of the first to sixth embodiments, and thus, like units are denoted by like numerals and details thereof are omitted.

### Eighth Embodiment

An eighth embodiment of the present invention relates to a scheme for identifying fraudulent clicking using software in accordance with the degree of dispersion of invalid clicked coordinates. When the user clicks on a superimposition image 10 in an advertisement image 20 via the input unit 23 while viewing the superimposition image 10, clicked coordinates are concentrated within the superimposition area. On the other hand, when software is used to randomly click on the advertisement image 20 including the superimposition image 10 many times, clicked coordinates are scattered in the entire area of the advertisement image 20 and the superimposition area. The CPU 11 determines the degree of dispersion of a group of clicked coordinates stored in the history storage 154. When the degree of the dispersion is greater than or equal to a threshold stored in the storage 15, the CPU 11 determines that the clicking is fraudulent.

The degree of the dispersion can be determined by, for example, extracting two arbitrary coordinates from multiple clicked coordinates and determining a distance between the two coordinates. The processing is performed with respect to multiple combinations of two coordinates and calculates an average value thereof. When the average value is greater than or equal to the threshold, the CPU 11 may determine that the clicking is fraudulent.

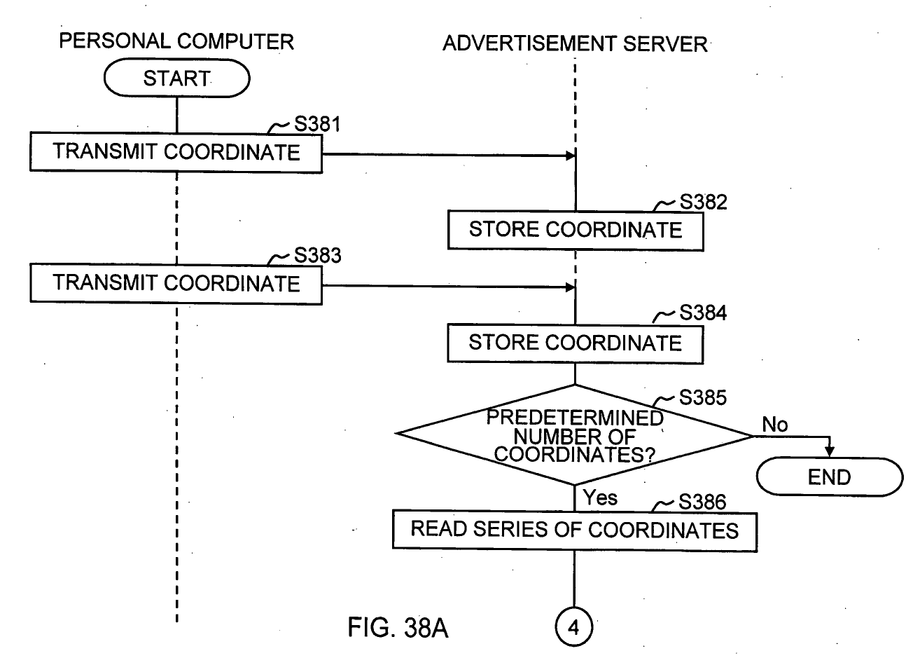

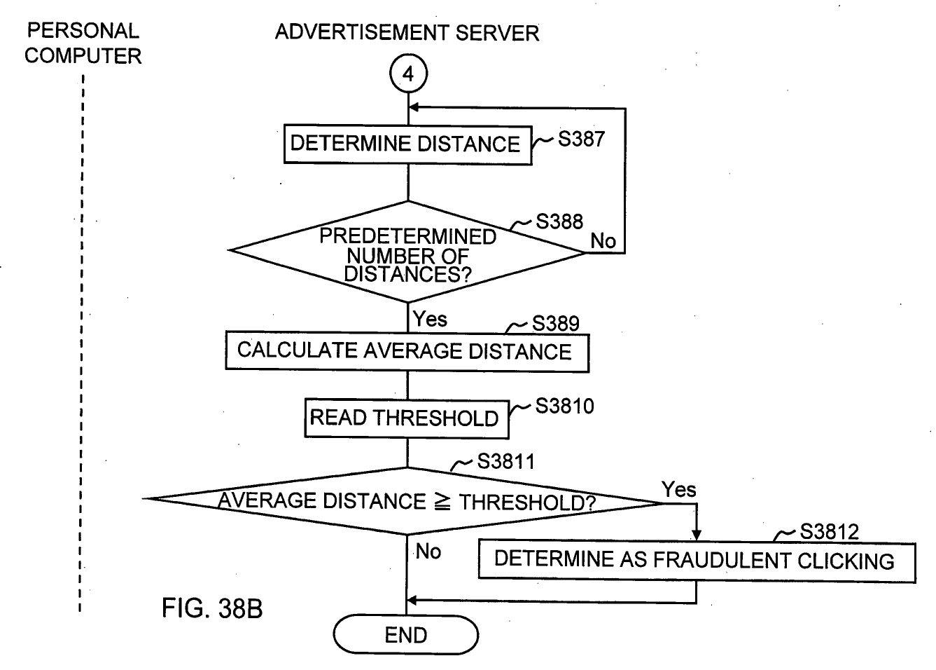

FIGS. 38A and 38B are diagrams illustrating a flowchart of a procedure for the fraud identifying processing according to an eighth embodiment of the present invention. In step S381, the CPU 21 of the personal computer 2 receives a clicked coordinate input via the input unit 23 and transmits the received clicked coordinate to the advertisement server 1. In step S382, the CPU 11 of the advertisement server 1 stores the transmitted clicked coordinate in the history storage 154, as described in the first embodiment. When another clicked coordinate is input by the user or software via the input unit 23 of the personal computer 2, the CPU 21 receives the clicked coordinate and transmits the received clicked coordinate to the advertisement server 1 in step S383.

In step S384, similarly, the CPU 11 of the advertisement server 1 stores the transmitted clicked coordinate in the history storage 154. Thereafter, in step S385, the CPU 11 determines whether a predetermined number of clicked coordinates is stored in the history storage 154. Upon determining that a predetermined number of clicked coordinates is not yet stored (No in step S385), the process ends. On the other hand, upon determining that a predetermined number of clicked coordinates is already stored (Yes in step S385), the CPU 11 reads the series of the predetermined number of clicked coordinates (e.g., 100 samples) stored in the history storage 154 in step S386.

In step S387, the CPU 11 determines a distance between two arbitrary coordinates. The determined distance is temporarily stored in the RAM 12. In step S388, the CPU 11 determines whether distances have been determined for a predetermined number (e.g., 30) of combinations of coordinates. Upon determining that distances with respect to the predetermined number of combinations of coordinates have not been determined (No in step S388), the process proceeds to step S387 in which the CPU 11 determines a distance with respect to another combination of two coordinates.

Upon determining that distances with respect to a predetermined number of combinations of coordinates have been determined (Yes in step S388), the CPU 11 reads all distances stored in the RAM 12 and calculates an average distance by dividing a sum of the read distances by number of combinations in step S389. In step S3810, the CPU 11 reads a threshold stored in the storage 15. In step S3811, the CPU 11 determines whether the calculated average distance is greater than or equal to the threshold. Upon determining that the average distance is greater than or equal to the threshold (Yes in step S3811), in step S3812, the CPU 11 determines that the clicking is fraudulent clicking using software. Information indicating the fraudulent clicking is stored in association with the clicked coordinates read (in step S386) from the history storage 154. Upon determining that the average distance is less than the threshold (No in step S3811) the CPU 11 ends the series of processing.

Configuration, other than the above-described configuration of the eighth embodiment, and operation thereof are analogous to those of the first to seventh embodiments, and thus, like units are denoted by like numerals and details thereof are omitted.

### Ninth Embodiment

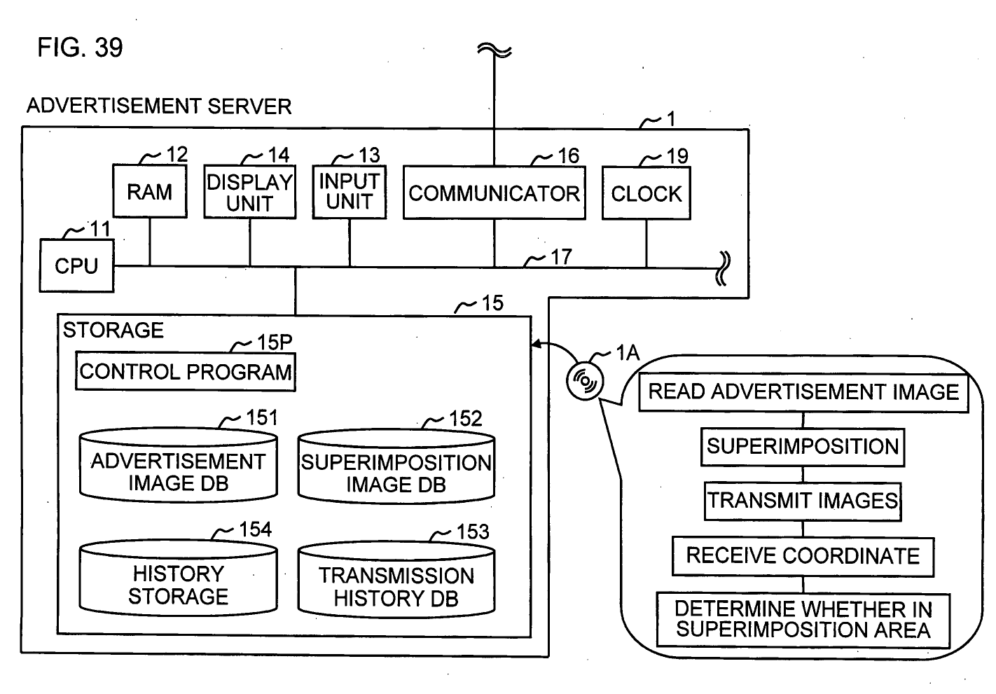

FIG. 39 is a block diagram illustrating a hardware configuration of an advertisement server according to a ninth embodiment of the present invention. A program for operating the advertisement server 1 according to the first to eighth embodiments can be stored in the storage 15 by causing a storage medium reader (not shown) to perform reading from a storage medium 1A, such as a CD-ROM (compact-disc read-only memory), or can be downloaded from another computer (not shown) connected via the communication network N. An example of such a configuration will be described below.

In FIG. 39, a program for reading data of an advertisement image 20, superimposing data of a superimposition image 10 thereon, transmitting data of the advertisement image 20 superimposed with the superimposition image 10, receiving a clicked coordinate, and determining whether the clicked coordinate exists within a superimposition area is downloaded to a server computer 1 from the portable storage medium 1A or another computer (not shown) via a communicator 16. The downloaded program is installed as a control program 15P in the storage 15. The program is loaded into a RAM 12 for execution. With this arrangement, the server computer 1 serves as the above-described advertisement server 1 according to the ninth invention.

Configuration, other than the above-described configuration of the ninth embodiment, and operation thereof are analogous to those of the first to eight embodiments, and thus, like units are denoted by like numerals and details thereof are omitted.

As described above, according to embodiments of the present invention, there is provided a data transmission method which can prevent billing based on fraudulent operation by superimposing, on a display image serving as a banner advertisement image, a superimposition image for prompting a user's operation and by determining that an operation is valid when the operation is performed on the superimposition image. There is also provided a data transmission apparatus which is able to appropriately change the form of a superimposition image to make it difficult to easily commit fraud.

What is claimed is:

1. A data transmission method for transmitting data of an image to be displayed on a web page, said data transmission method being executed by a data transmission apparatus, said data transmission apparatus being capable of communicating with a user computer, said data transmission method comprising the steps of:
reading data of a display image stored in a storage on receiving a request of obtaining data of the display image;
storing, in the storage, data of a superimposition image and data of a superimposition area for the superimposition image in the display image, said superimposition area being defined depending on the superimposition image;
superimposing the superimposition image on the superimposition area in the display image;
transmitting data of the display image superimposed with the superimposition image to the user computer;
receiving, from the user computer, position data indicative of a position in the display image superimposed with the superimposition image; and
determining whether the position is within the superimposition area.

2. A data transmission system comprising:
a server computer for transmitting data of a web page, said server computer connected to a communication network;
a client computer for receiving data of the web page, said client computer being connected to the communication network, said client computer including:
an input unit for receiving position data indicative of a position, where a user has operated, in a display image superimposed with a superimposition image, and
a position transmitter for transmitting the position data; and a data transmission apparatus for transmitting, in response to a request of obtaining data of the display image from the client computer, data of the display image to be displayed on the web page, said data transmission apparatus being connected to the communication network, said data transmission apparatus including:
a reader for reading data of a display image stored in a storage on receiving the request of obtaining data of the display image,
a storer for storing, in the storage, data of a superimposition image and data of a superimposition area for the superimposition image in the display image, said superimposition area being defined depending on the superimposition image,
a superimposer for superimposing the superimposition image on the superimposition area in the display image,
a transmitter for transmitting data of the display image superimposed with the superimposition image to the client computer,
a receiver for receiving the position data transmitted from the client computer, and
a determiner for determining whether the position is within the superimposition area.

3. A data transmission apparatus for transmitting data of a display image to be displayed on a web page to a client computer, said data transmission apparatus comprising:
a request receiver for receiving a request of obtaining data of a display image;
a display image reader for reading data of the display image stored in a storage on receiving the request of obtaining data of a display image;
a storer for storing, in the storage, data of a superimposition image and data of a superimposition area for the superimposition image in the display image, said superimposition area being defined depending on the superimposition image;
a superimposer for superimposing the superimposition image on the superimposition area in the display image;
a transmitter for transmitting data of the display image superimposed with the superimposition image to the client computer;
a data receiver for receiving, from the client computer, position data indicative of a position in the display image superimposed with the superimposition image; and
a determiner for determining whether the position is within the superimposition area.

4. The data transmission apparatus of claim 3, further comprising:
a counter for counting number of times of determinations in which the position is determined as being within the superimposition area.

5. The data transmission apparatus of claim 3, wherein the storage further stores a history of results of the determinations, said data transmission apparatus further comprising:
a fraud determiner for determining a fraudulent operation on the basis of the history of results of the determinations stored in the storage.

6. The data transmission apparatus of claim 3, wherein the storage stores data of multiple superimposition images and data of superimposition areas, said data transmission apparatus further comprising:
a superimposition data reader for reading data of a superimposition image selected randomly or regularly and a superimposition area corresponding to the selected superimposition image from the storage.

7. The data transmission apparatus of claim 3, further comprising:
a superimposition image generator for generating the superimposition image, wherein
said storage stores data of the superimposition image generated by the superimposition image generator.

8. The data transmission apparatus of claim 7, wherein
said superimposition image generator generates a superimposition image having a size determined in accordance with a size of the display image stored in the storage.

9. The data transmission apparatus of claim 7, wherein
said superimposition image generator generates a superimposition image having color data determined in accordance with color data of the display image stored in the storage.

10. The data transmission apparatus of claim 3, further comprising:
an extractor for extracting a contour image of the superimposition image; and
a contour superimposer for superimposing the contour image or associated image of the contour image on the display image superimposed with the superimposition image.

11. The data transmission apparatus of claim 3, wherein
said superimposition image includes an image of characters prompting operations on said superimposition image.

12. The data transmission apparatus of claim 11, further comprising:
a character superimposer for superimposing an associated image of the image of characters on the display image.

13. The data transmission apparatus of claim 3, further comprising:
an associated image generator for generating an associated image of the superimposition image, said associated image having a shape or color different from the superimposition image; and
an associated image superimposer for superimposing the associated image on the display image.

14. The data transmission apparatus of claim 7, wherein
said superimposition image generator generates the superimposition image by changing a coefficient stored in the storage.

15. The data transmission apparatus of claim 3, wherein
said superimposition image is processed as to have color gradually changing from a center of the superimposition image toward a periphery thereof.

16. The data transmission apparatus of claim 11, wherein
said superimposition image is processed as to be transparent except for the image of characters.

17. The data transmission apparatus of claim 5, wherein
said fraud determiner determinates a fraudulent operation in accordance with a ratio of number of times of determinations in which the position is determined as being within the superimposition area to a total number of determinations of whether the position is within the superimposition area.

18. The data transmission apparatus of claim 17, further comprising:
a scale determiner for determining a scale on the basis of a size of the superimposition area and a size of the display image,
wherein
said fraud determiner determinates a fraudulent operation on the basis of the scale and the ratio.

19. The data transmission apparatus of claim 3, wherein said storage further stores a series of position data received by the data receiver and a model of position including multiple position data, said data transmission apparatus further comprising:
a correlation determiner for determining a degree of correlation on the basis of the series of position data and the model of position; and
a fraud determiner for determining a fraudulent operation in accordance with the degree of correlation.

20. The data transmission apparatus of claim 3, wherein said storage further stores a series of position data received by the data receiver, said data transmission apparatus further comprising:
a fraud determiner for determining a fraudulent operation on the basis of degree of dispersion of the series of position data.

21. A computer readable storage medium storing a program of instructions to a computer for executing a data transmission method for transmitting data of an image to be displayed on a web page, said computer being capable of communicating with a user computer, said data transmission method comprising the steps of:
reading data of a display image stored in a storage on receiving a request of obtaining data of the display image;
storing, in the storage, data of a superimposition image and data of a superimposition area for the superimposition image in the display image, said superimposition area being defined depending on the superimposition image;
superimposing the superimposition image on the superimposition area in the display image;
transmitting data of the display image superimposed with the superimposition image to the user computer;
receiving, from the user computer, position data indicative of a position in the display image superimposed with the superimposition image; and
determining whether the position is within the superimposition area.
